(19) United States
(12) Patent Application Publication
(10) Pub. No.: US 2016/0021512 A1
(43) Pub. Date: Jan. 21, 2016

(54) SYSTEMS AND METHODS FOR INDOOR LOCATION SERVICES

(71) Applicant: RETAIL OPTIMIZATION INTERNATIONAL INC., Miami Beach, FL (US)

(72) Inventors: Charles William Krallman, Beef Island (VG); Adam J. Fleming, Cheadle Hulme (GB); Ian Andrew Woods, Liverpool (GB)

(21) Appl. No.: 14/511,108

(22) Filed: Oct. 9, 2014

Related U.S. Application Data
(63) Continuation-in-part of application No. 14/209,939, filed on Mar. 13, 2014.
(60) Provisional application No. 61/779,458, filed on Mar. 13, 2013.

(51) Int. Cl. H04W 4/04; H04W 24/10

(52) U.S. Cl. CPC H04W 4/04; H04W 24/10

(57) ABSTRACT

Many indoor location services do not require precise knowledge of the position of a mobile device, but simply whether a mobile device is within a particular zone of an indoor area. Existing signals in an indoor space may provide enough information to distinguish between different zones of an indoor area, allowing a server to provide indoor location services without requiring the installation of new signal sources in the indoor area.

### CROSS-REFERENCE TO RELATED APPLICATIONS

This application is a continuation-in-part of U.S. patent application Ser. No. 14/209,939, filed on Mar. 13, 2014, which claims priority to U.S. Provisional Application Ser. No. 61/779,458, filed on Mar. 13, 2013, of which the contents of both are hereby incorporated by reference in their entirety.

### INTRODUCTION

A user's location within an indoor space may be important to the user, retailers, manufacturer brands, advertisers, or others. Accurate indoor location services allow contextual messages, Web pages, coupons, surveys, video clips, and other kinds of content to be delivered to customers' mobile devices based on where they are in a building. But the Global Positioning System (GPS) location services that provide accurate positioning information outside are less accurate indoors.

Consequently, many companies are attempting to provide precise indoor location solutions, and have proposed technologies relying variously on magnetic field detection, WI-FI signals, BLUETOOTH signals, audio beacons, and more. Generally, the more accurate the position, the greater is the need to add enabling hardware infrastructure to the indoor space. The high cost of equipment installation and maintenance and the associated costs and interruption to business caused by refitting these systems in existing spaces has been a substantial barrier to adoption. Also, many systems are not consistently accurate, and many do not work consistently across all mobile platforms.

### SUMMARY

There is therefore a need for improved indoor location services. It is a realization of the inventor that most classes of the mobile-based interior location problem do not require real-time identification of a free-space location of the mobile device, but only a backwards-looking identification of a zone of a plurality of zones comprising an indoor area. As illustrative examples, a store providing coupons to visitors to a particular department and a museum providing visitors information regarding a particular gallery do not need to know the precise longitude, latitude, and altitude of their visitors' smartphones or tablet computers, but may meet their needs by determining whether the visitors' mobile devices were in a particular zone a few seconds before. Identifying whether a mobile device was within a particular zone may be determined with high accuracy without requiring extensive equipment installation and calibration. Accordingly, the systems and methods described herein relate to identifying a predetermined zone of an indoor area based on a measurement package received from a mobile device.

In certain aspects, the systems and methods described herein relate to identifying a zone of an indoor area in which a mobile device is located. A communication processor may receive a first measurement package from a mobile device in an indoor area and identify the type of the mobile device from which the first measurement package was received. The indoor area may be associated with a plurality of zones. A location database may store a first model associating a plurality of measurement packages with the plurality of zones. A location processor may be in communication with the communications processor and the location database. The location processor may calculate a first plurality of probabilities based on a first measurement package and the first model. The first measurement package may be received by the communications processor. Each probability in the first plurality of probabilities may be associated with a zone of the plurality of zones. The location processor may identify a zone corresponding to the first measurement package based on the first plurality of probabilities.

The location database may be further configured to store a second model associating each zone of the plurality of zones with other zones of the plurality of zones. The location processor may calculate a second plurality of probabilities based on the second measurement package and the first model. The second measurement package may be received by the communications processor after the first measurement package. Each probability in the second plurality of probabilities may be associated with a zone of the plurality of zones. The location processor may modify at least one probability of the first plurality of probabilities based on the second plurality of probabilities and the second model.

The location processor may calculate a third plurality of probabilities based on a third measurement package and the first model. Each probability in the third plurality of probabilities may be associated with a zone of the plurality of zones. The location processor may modify at least one probability of the third plurality of probabilities based on the modified first plurality of probabilities, the second plurality of probabilities, and the second model. The location processor may identify a zone corresponding to the third measurement package based on the modified third plurality of probabilities.

The location processor may calculate a fourth plurality of probabilities based on the second model and the zone corresponding to the third measurement package. Each probability in the fourth plurality of probabilities may be associated with a zone of the plurality of zones.

The location processor may modify the second model based on the zone corresponding to the third measurement package. The second model may be a behavioral model. The second model may be a statistical model. The communication processor may provide content to the mobile device based on the zone corresponding to the first measurement package. The communication processor may provide content to the mobile device based on the zone corresponding to the third measurement package. The communication processor may provide content to the mobile device based on one or more probabilities of the fourth plurality of probabilities. The location processor may identify a transaction associated with the mobile device.

The location processor may identify the indoor area. The indoor area may be identified based on the first measurement package. The indoor area may be identified based on a Global Positioning System (GPS) measurement. The indoor area may be identified based on a cellular tower signal. The indoor area may be identified based on an application run by the mobile device.

The first measurement package may indicate a type of the mobile device. The first measurement package may include a plurality of measurements taken during a predetermined period of time. The first measurement package may indicate an orientation of the mobile device. The first measurement package may include information based on one or more of a Global Positioning System (GPS) measurement, a BLUETOOTH signal strength, a WI-FI signal strength, a cellular telephone signal strength, a local magnetic field strength, a local magnetic field direction, a time, a pressure, a temperature, gyroscope data, video data, audio data, heart rate data, and respiratory rate data.

The location processor may associate an identified zone corresponding to the first measurement package with a first route comprising a sequence of identified zones associated with the mobile device. Alternatively, the location processor may associate an identified zone corresponding to the third measurement package with a first route comprising a sequence of identified zones associated with the mobile device. The location processor may calculate a similarity score between the first route and a second route. The location processor may modify at least one probability of the first plurality of probabilities based on the similarity score. The communication processor may provide content to the mobile device based on the similarity score. The first route may comprise an elapsed time associated with each of the identified zones. The first route may comprise motion information based on the motion of the mobile device, each zone having associated motion information.

### BRIEF DESCRIPTION OF THE DRAWINGS

The systems and methods described herein are set forth in the appended embodiments. However, for the purpose of explanation, several implementations are set forth in the following figures.

FIG. 1A is a block diagram of an indoor area with varying signals, according to an illustrative implementation;

FIG. 1B is a block diagram of an indoor location service, according to an illustrative implementation;

FIG. 1C is a block diagram of an indoor area with locational zones, according to an illustrative implementation;

FIG. 1D is a block diagram of a locational zone evaluation system, according to an illustrative implementation;

FIG. 2A is a block diagram of a mobile locational device, according to an illustrative implementation;

FIG. 2B is a block diagram of a indoor location server, according to an illustrative implementation;

FIG. 3 is a block diagram of a computing device for performing any of the processes described herein;

FIG. 4A is a flow chart of a process for identifying whether a mobile device is in a classifiable indoor area, according to an illustrative implementation;

FIG. 4B is a flow chart of a process for classifying the position of a mobile device, according to an illustrative implementation;

FIG. 4C depicts an exemplary neural network for classifying an indoor location;

FIG. 5A is a block diagram of zones of an indoor area, according to an illustrative implementation;

FIG. 5B is a state transition table indicating possible transitions between the zones of FIG. 5A, according to an illustrative implementation;

FIG. 5C is a state transition table weighing possible transitions between the zones of FIG. 5A, according to an illustrative implementation;

FIG. 6 is a flow chart of a process for identifying whether a mobile device is following a route, according to an illustrative implementation;

FIG. 7 is a flow chart of a process for training a neural network to identify an indoor location based on available measurement data, according to an illustrative implementation;

FIG. 8A is a flow chart of a process for providing content associated with a predetermined area, according to an illustrative implementation;

FIG. 8B is an exemplary process diagram depicting a retailer providing content associated with a predetermined area, according to an illustrative implementation;

FIG. 8C is an exemplary process diagram depicting a manufacturer providing content associated with a predetermined area, according to an illustrative implementation; and

FIG. 8D is an exemplary process diagram depicting directing employees to an area, according to an illustrative implementation.

### DETAILED DESCRIPTION

In the following description, numerous details are set forth for the purpose of explanation. However, one of ordinary skill in the art will realize that the implementations described herein may be practiced without the use of these specific details and that the implementations described herein may be modified, supplemented, or otherwise altered without departing from the scope of the invention.

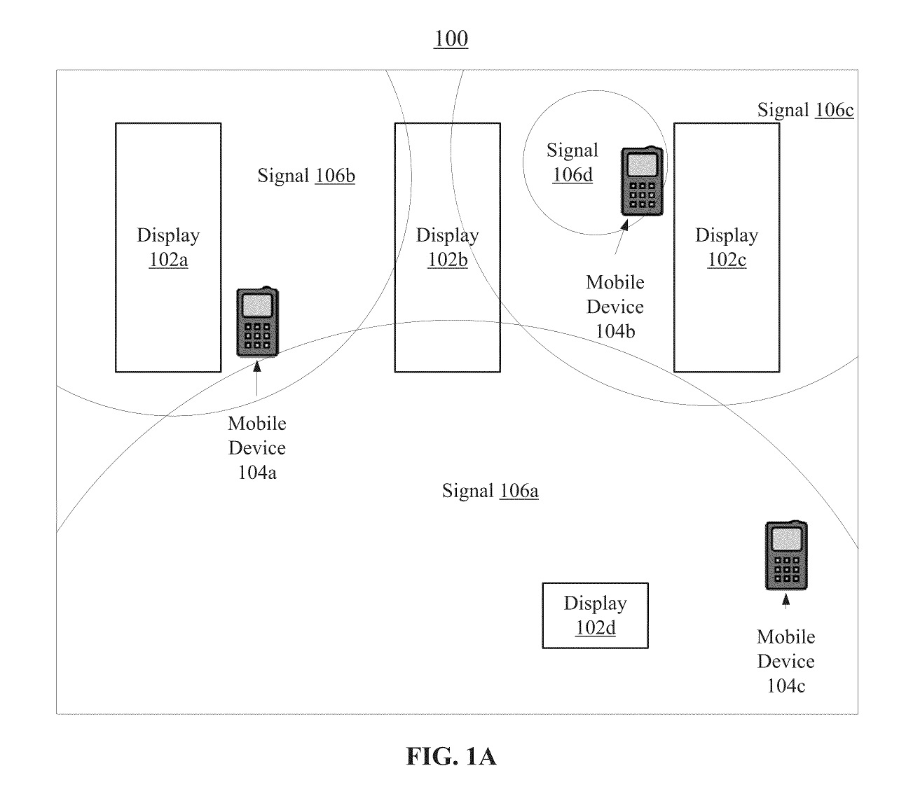

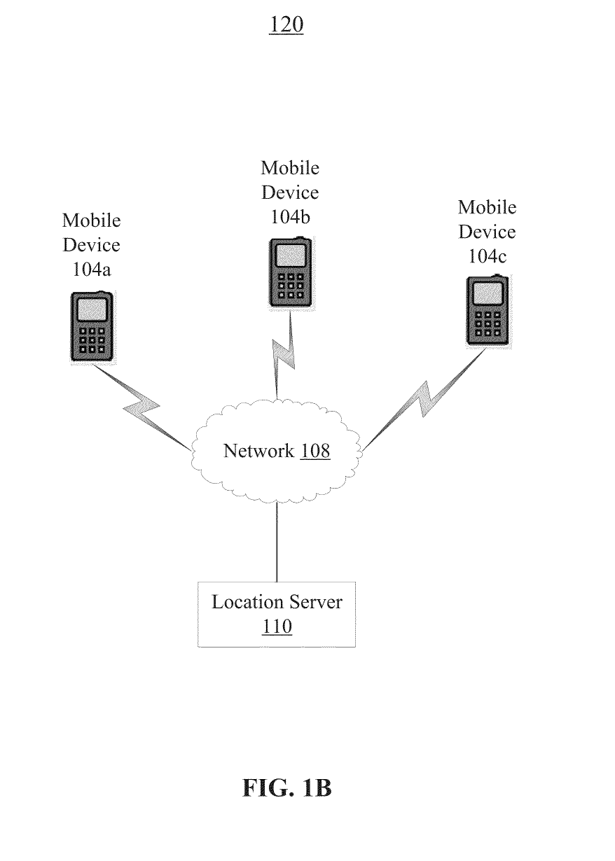

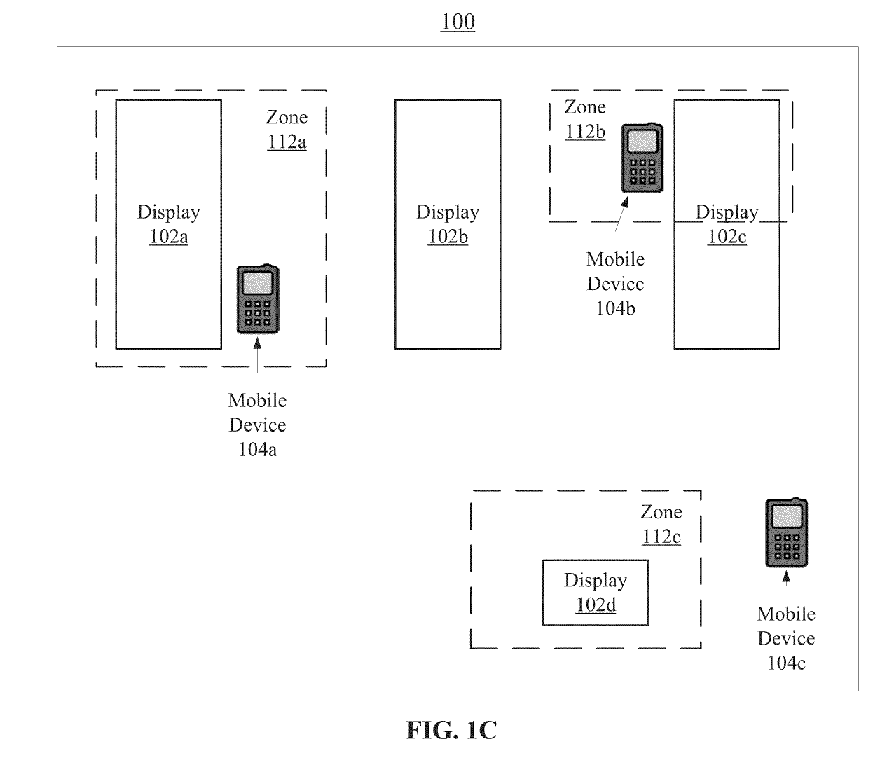

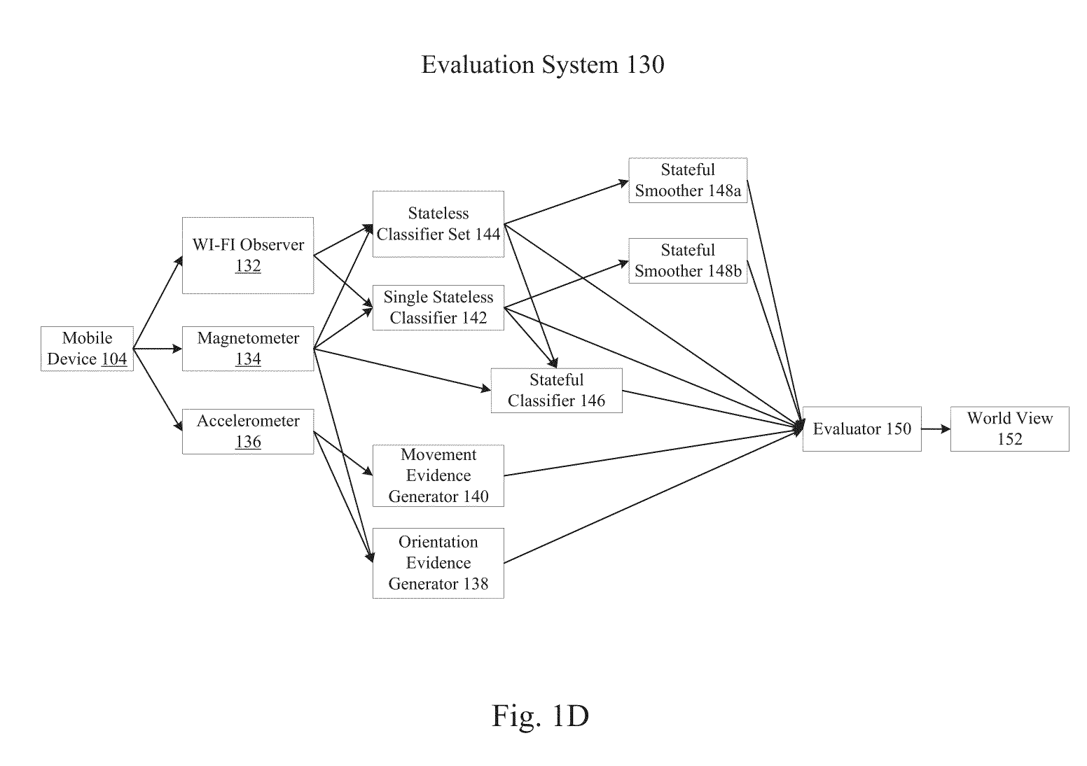

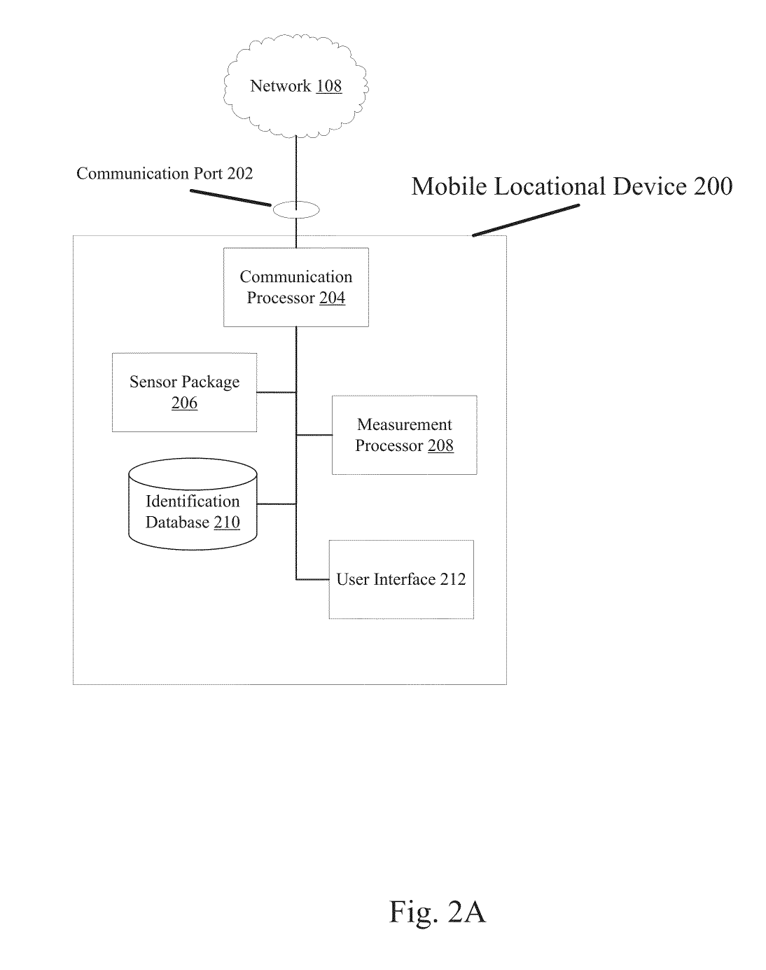

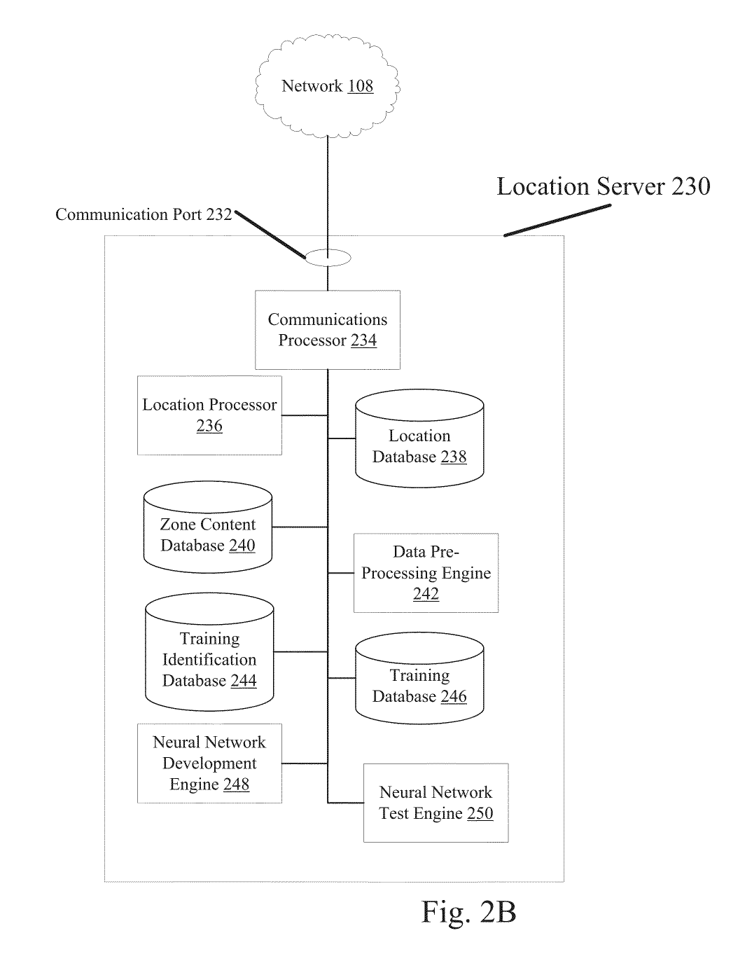

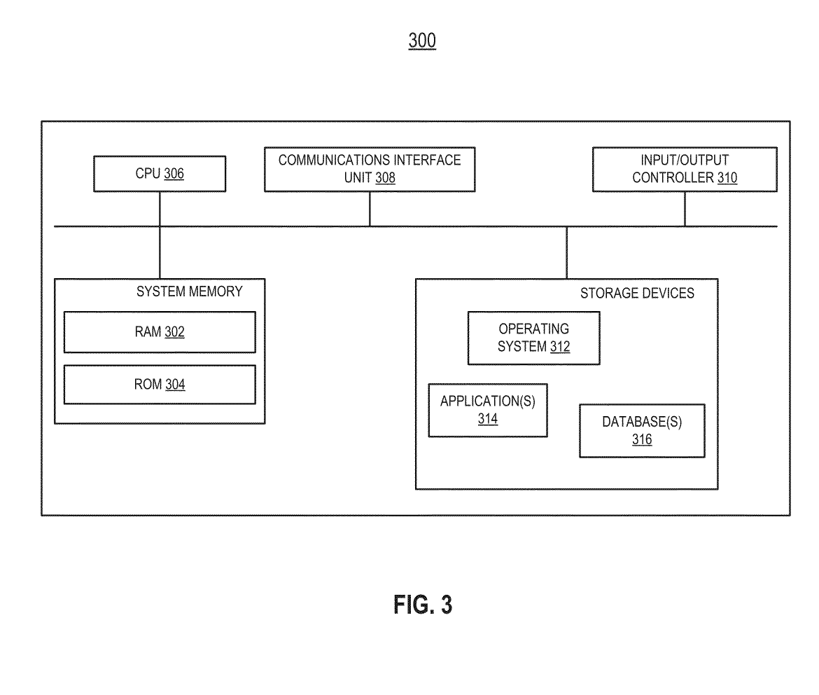

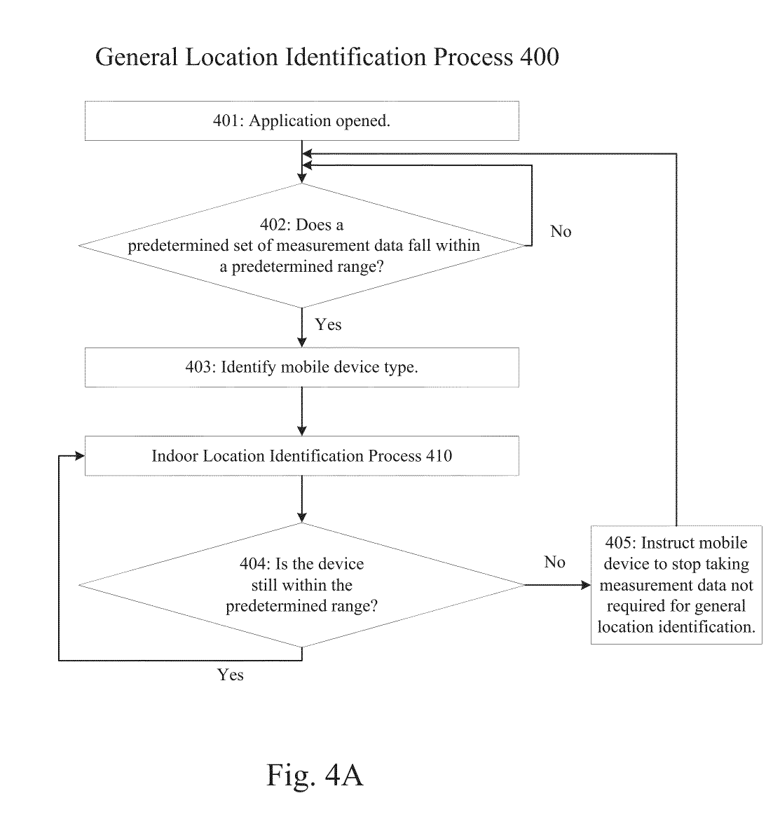

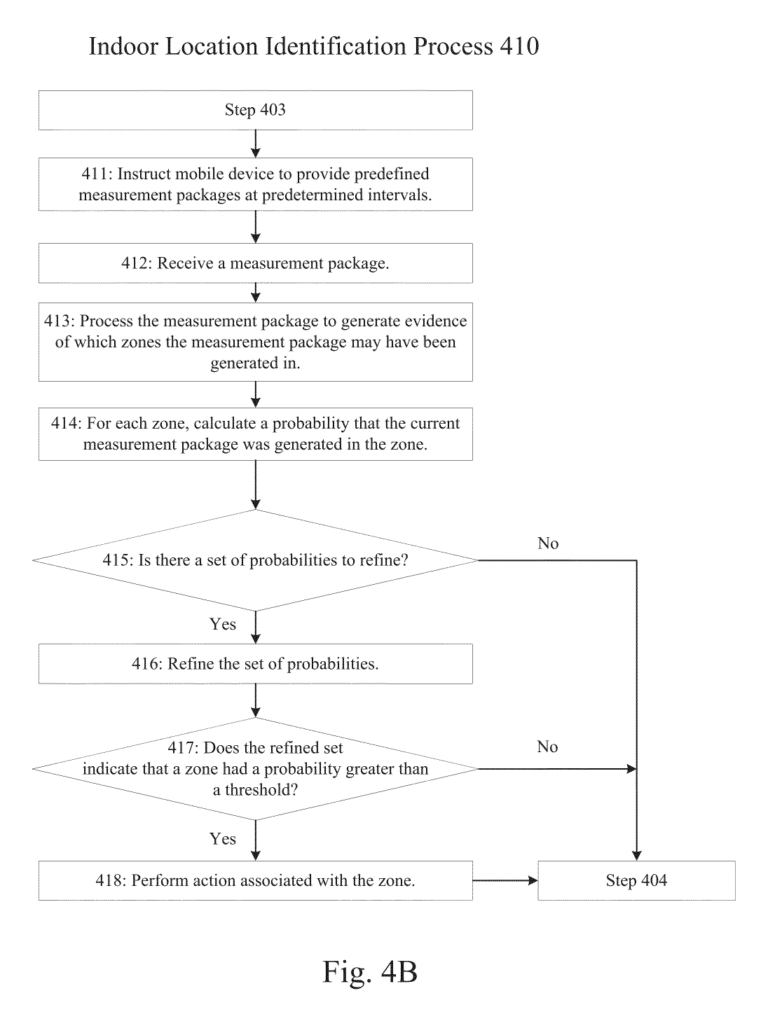

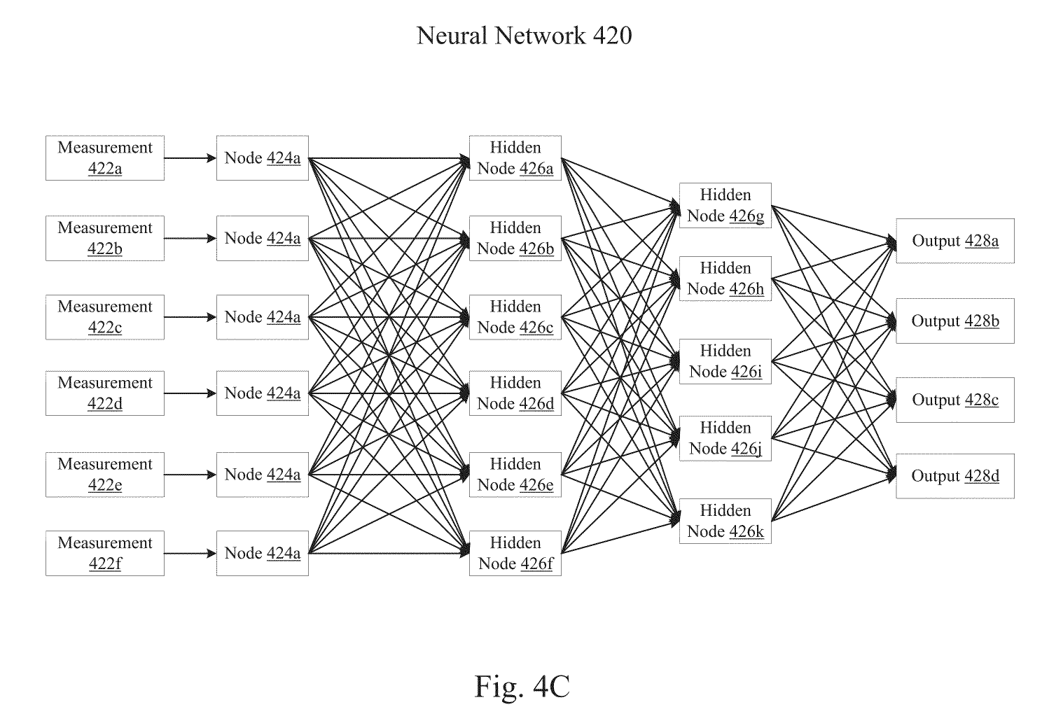

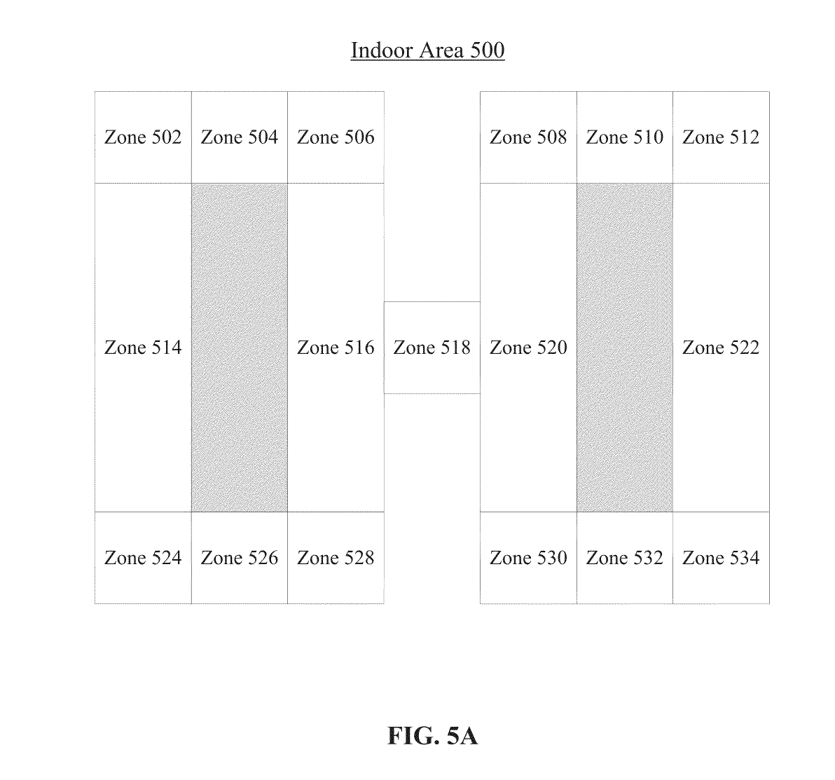

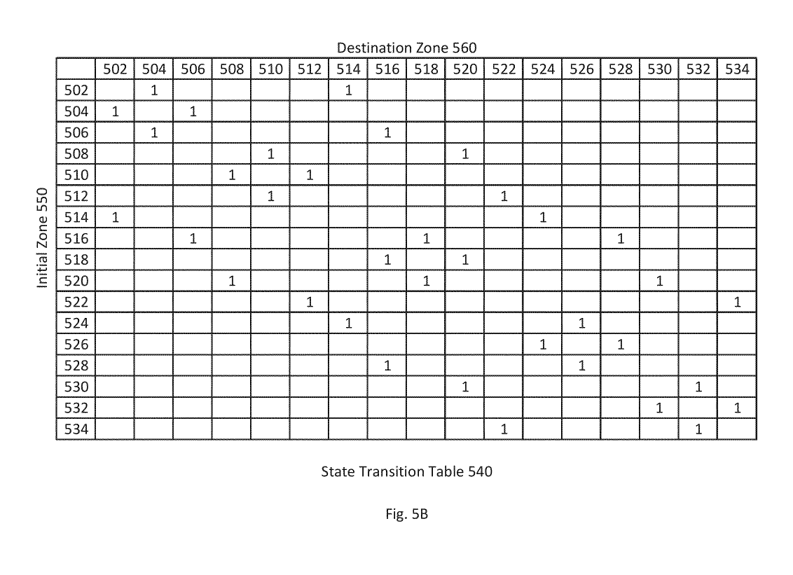

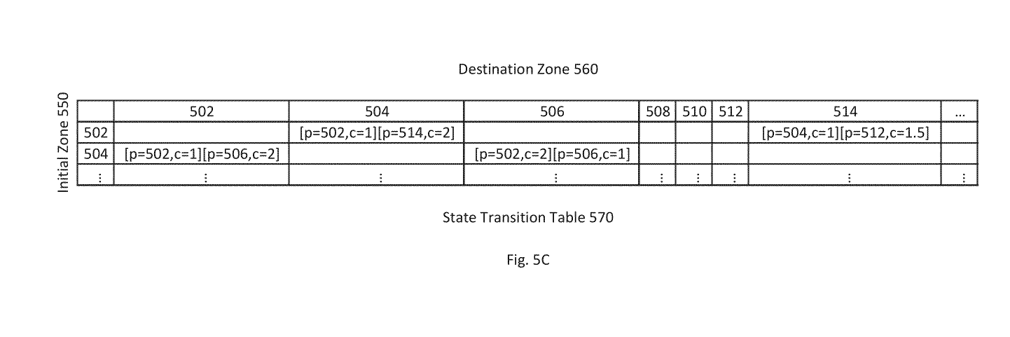

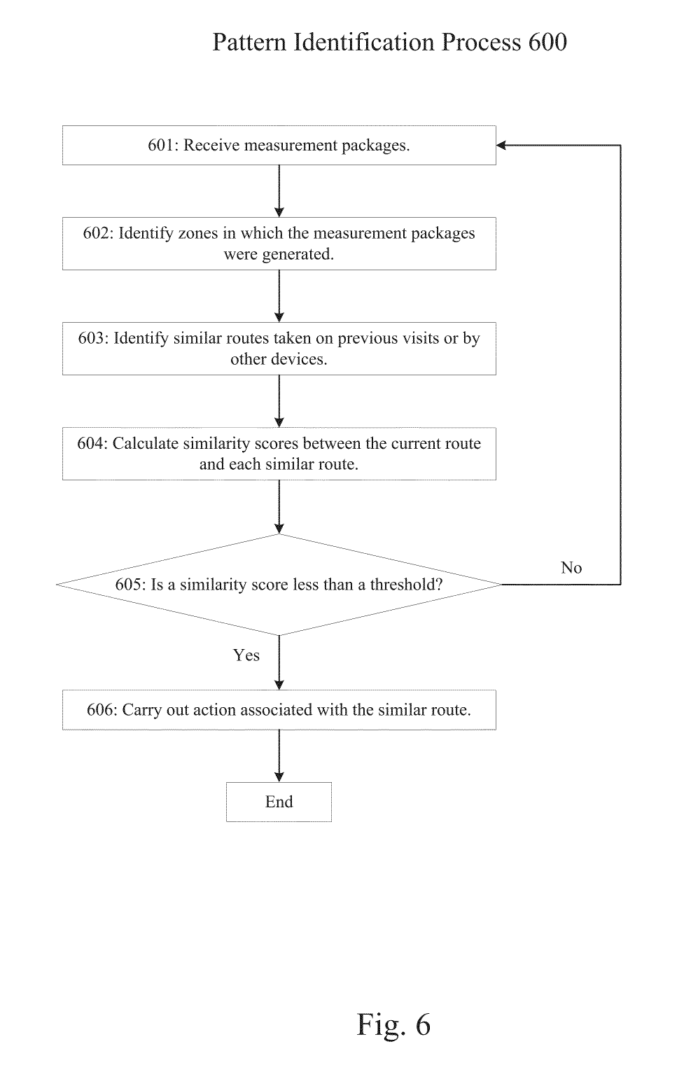

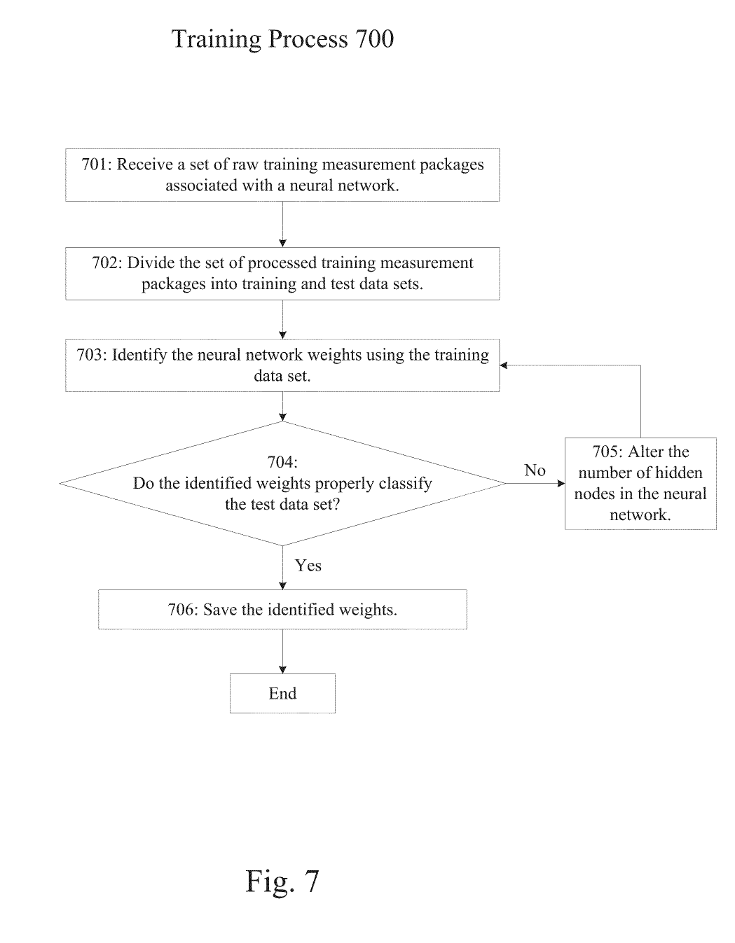

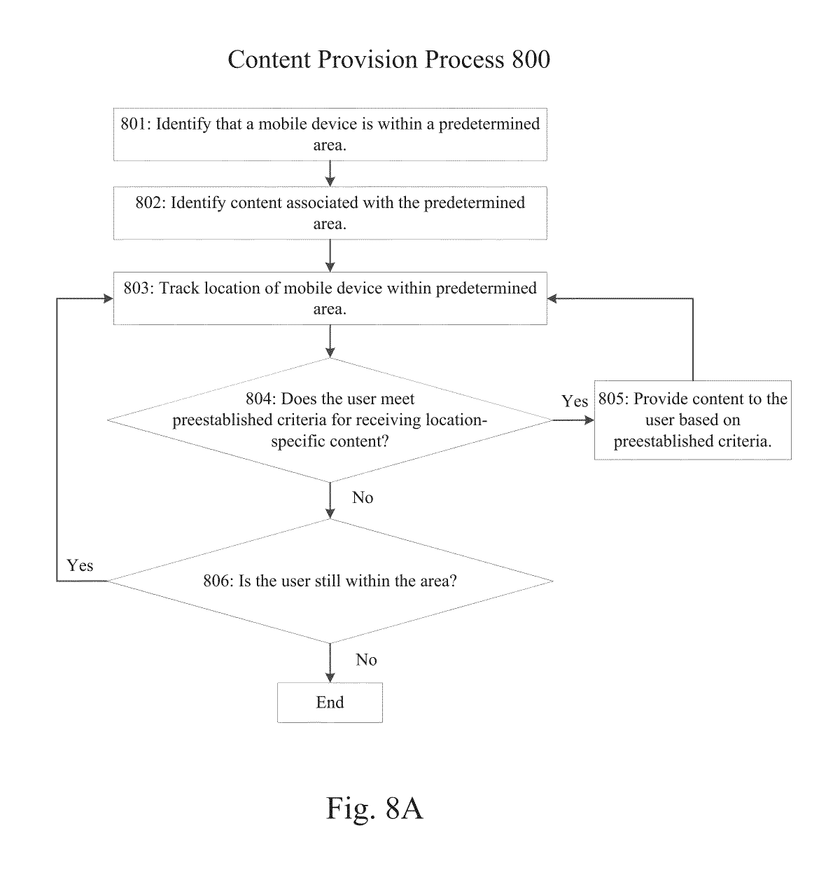

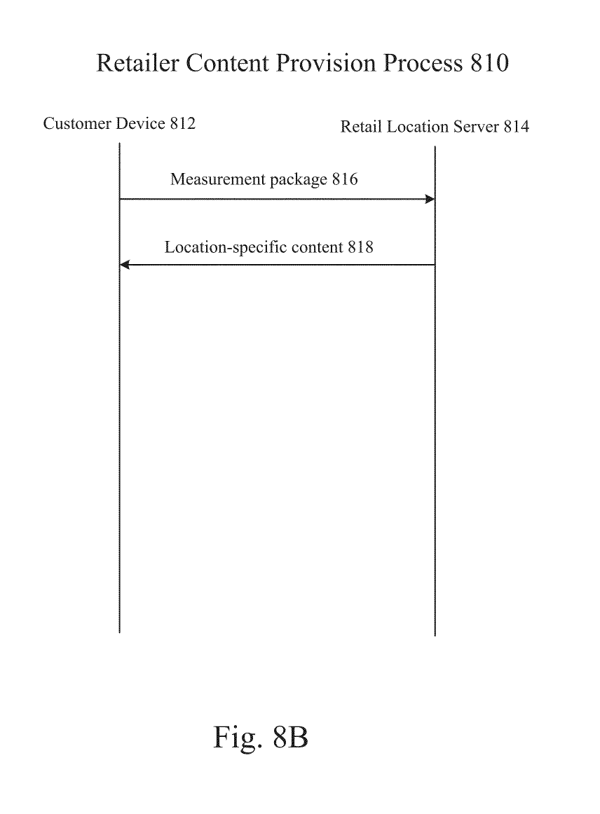

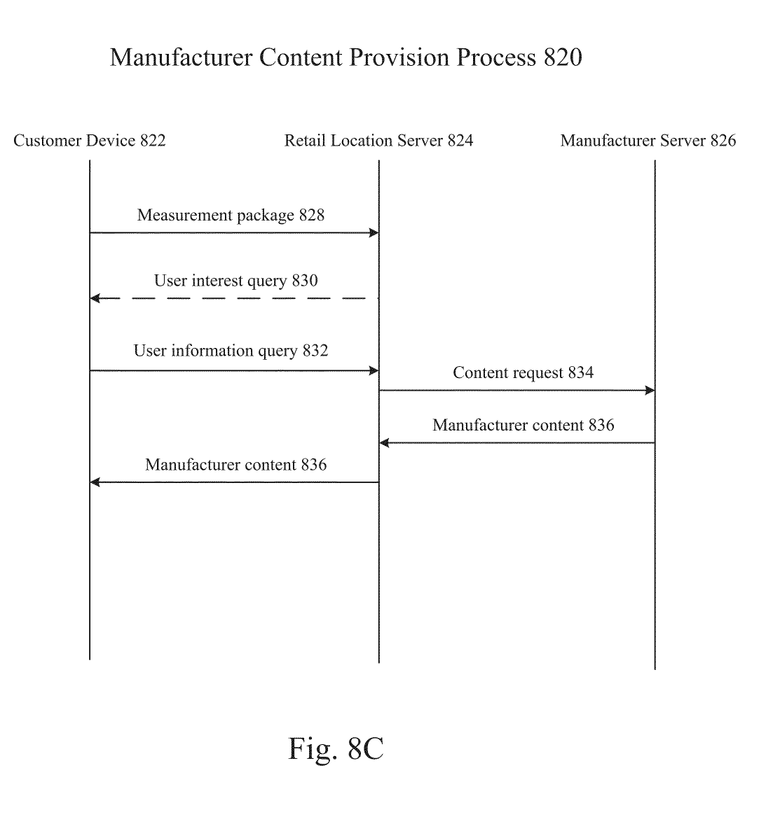

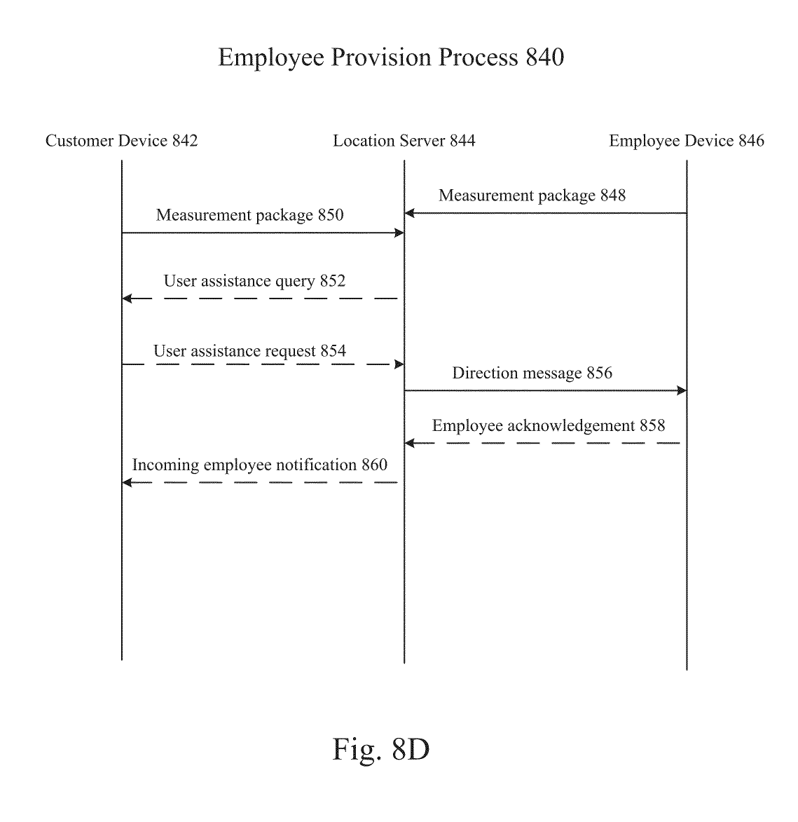

The systems and methods described herein relate to identifying whether a mobile device is located within a predetermined zone of an indoor area. FIGS. 1A-D provide an overview of a system classifying a mobile device as being in a zone, with FIG. 1A depicting an indoor area with signals that may be detected to determine whether a mobile device is located within a zone, FIG. 1B depicting the connection between a mobile device and a server that provides location services, FIG. 1C illustrating how an indoor space may include predefined zones, and FIG. 1D illustrating an overall system identifying a zone in which a mobile device is located. FIG. 2A illustrates the components of a mobile device that may be classified as being in a predetermined zone, while FIG. 2B illustrates the components of a location server that may perform the classification. FIG. 3 depicts a computing device that may be used as a component of any of the systems described herein or as a computing device for performing any of the processes described herein. FIG. 4A depicts a process for identifying whether a mobile device is in an indoor area with predetermined zones. FIG. 4B depicts a process for classifying whether the mobile device is in one of the predetermined zones. FIG. 4C depicts a neural network that may be used by the process described in relation to FIG. 4B. FIGS. 5A-C depict relations between zones of an indoor area, with FIG. 5A depicting zones of an indoor area, FIG. 5B depicting a transition table indicating possible transitions between the zones of FIG. 5A, and FIG. 5C depicting a transition table indicating costs for making a transition between the zones of FIG. 5A. FIG. 6 depicts a process for identifying whether a mobile device is following a route similar to those taken on a previous visit or by other mobile devices. FIG. 7 depicts a process for training a neural network such as that of FIG. 4C. FIGS. 8A-D depict processes for providing content to a mobile device associated with a zone of an area, with FIG. 8A depicting a general content provision process, FIG. 8B depicting an exemplary process of a retailer providing content to a customer in a predetermined area, FIG. 8C depicting an exemplary process of a manufacturer providing content to a customer in a retail store, and FIG. 8D depicting an exemplary process of employees being directed to areas in which their services are needed.

### General System Description

FIG. 1A is an illustrative block diagram of an indoor area 100 in which indoor location services may be provided. Indoor area 100 may be a store, a warehouse, a hospital, a factory, a library, a museum, a theater, or some other suitable indoor area. Indoor area 100 may include displays 102a-d (collectively, displays 102), which may include shelving with products for sale, advertisements, artwork, or some other suitable object of interest. As depicted, mobile devices 104a-c (collectively, mobile devices 104) are located within indoor area 100. Mobile devices 104 may measure one or more signals 106a-d (collectively, signals 106), and are described in more detail in relation to FIG. 2A. Signals 106 may include magnetic fields, radio frequency (RF) signals, sonic signals, infrared (IR) signals, ultraviolet (UV) signals, visual signals, barometric signals, temperature signals, or other signals that can be used to identify a location. RF signals may include WI-FI signals, BLUETOOTH signals, GPS signals, amplitude modulation (AM) or frequency modulation (FM) radio signals, cellular telephone base station signals, or other suitable RF signals. The measurements of the one or more signals 106 may serve as a basis for identifying the location of the measuring mobile device 104, as described in relation to FIG. 4B.

FIG. 1B is an illustrative block diagram of an indoor location system 120. Mobile devices 104 provide measurement data via network 108 to location server 110. In an embodiment, measurement data may comprise the measured signal data. In another embodiment, measurement data may comprise information based on the measured signal data, such as an estimated location. Measurement data may comprise information based on the measured signals. Information based on the measured signals may include one or more of: a location estimate using measured signals, information derived from filtering or otherwise processing measured signals, information derived from geofencing, predictions based on measured signals, and information based on physiological measurements such as heart or respiration rate. Network 108 may be a local area network (LAN), the Internet, or some other suitable computer network. The mobile devices may connect to network 108 using a WI-FI connection, a cellular data connection, or other suitable network connection. Location server 110 may be a server, a personal computer, a mainframe, a cluster of computing devices, or some other suitable computing device, and is described in more detail in relation to FIG. 2B. Location server 110 may be connected to network 108 through a WI-FI connection, an Ethernet connection, or other suitable network connection, and receives measurement data generated by a mobile device 104 through network 108. Based on the received measurement data, location server 110 may identify whether the mobile device 104 has been in a zone of indoor area 100, and may provide content to or request further measurement data from the mobile device 104 based on the identified zone.

FIG. 1C is an illustrative block diagram of an indoor area 100 in which an indoor locational service may classify a mobile device 104 as being in a predefined zone. Zones 112a-c (collectively, zones 112) are predefined regions of indoor area 100, and are associated with a set of measurement data by location server 110. If a mobile device 104 generates measurement data that falls within a range associated with a zone 112, location server 110 may identify the mobile device 104 as being within the zone 112 and provide the mobile device 104 with content associated with the zone 112. As an illustrative example, if display 102a is a collection of greeting cards on sale, location server 110 may provide mobile device 104a with greeting card coupons. As depicted, no mobile device 104 is within zone 112c: no mobile device 104 is generating measurement data within the range associated with zone 112c. In some implementations, zones 112 may differ in one or more of number, size, and shape from the depicted zones 112.

Indoor location system 120 identifies whether a mobile device 104 is within a zone 112 of indoor area 100, and, if so, which zone 112 the mobile device 104 is within. A mobile device 104 may measure those signals 106 detectable by the mobile device 104, and may transmit those measurements to location server 110 via network 108. Location server 110 identifies whether the measurements provided indicate that mobile device 104 is in a zone 112, and may provide content or commands associated with the zone 112 to the mobile device 104 if they do.

FIG. 1D is an illustrative block diagram of an evaluation system 130, which may be indoor location system 120. In evaluation system 130, a mobile device 104 may include a number of measurement devices, here depicted as including a WI-FI observer 132 that measures WI-FI signal strengths, a magnetometer 134 that measures magnetic field strengths and orientations, and an accelerometer 136 that measures movement of the mobile device 104. In some implementations, mobile device 104 may include other or alternative measurement devices. Measurements from each measurement device of mobile device 104 may be processed to identify zones that the mobile device 104 is likely to be in and movements that the mobile device 104 is likely to have made. As depicted, measurements are processed—whether directly or by processing the output of other measurement processors—by orientation evidence generator 138, movement evidence generator 140, one or more single stateless classifiers 142, stateless classifier set 144, stateful classifier 146, stateful smoothers 148a and 148b, and evaluator 150, each of which may be implemented on mobile device 104, location server 110, or a combination of thereof. In some implementations there may be a different number of one or more of orientation evidence generators 138, movement evidence generators 140, single stateless classifiers 142, stateless classifier sets 144, stateful classifiers 146, stateful smoothers 148, and evaluators 150. Processing a set of measurements generates a set of probabilities describing which zones the set of measurements were likely to have been made in, which are stored in world view 152.

Orientation evidence generator 138 may determine a physical orientation of the mobile device 104, while movement evidence generator 140 may determine a relative displacement of the mobile device 104, a speed of mobile device 104, or some other suitable information regarding movement by mobile device 104. Evidence from orientation evidence generator 138 may be combined with evidence from movement evidence generator 140 to determine a displacement of the mobile device 104 within an indoor area: as an illustrative example, if orientation evidence generator 138 indicates that the mobile device 104 was perpendicular to the ground and pointing north, and the movement evidence generator 140 indicates that the mobile device 104 traveled 10 feet to its right, then mobile device 104 traveled 10 feet to the east.

A single stateless classifier 142 identifies a zone consistent with the measurements taken by mobile device 104 without reference to any previous measurements. Stateless classifier set 144 identifies a set of zones that are consistent with the measurements taken by mobile device 104 without reference to any previous measurements. As an illustrative example, if WI-FI signal strengths are consistent with both a first zone and a second zone but are more likely to have been measured in the first zone, a single stateless classifier 142 associated with the first zone may indicate that the measurement was taken in the first zone while the stateless classifier set 144 may indicate that the measurement was likely taken in the first zone but that there is still a probability that the measurement was taken in the second zone. Output from one or more of single stateless classifiers 142, stateless classifier set 144, and sensor processors such as magnetometer 134 may be provided to stateful classifier 146, which compares its input with historical data or classifications to identify which zone a measurement was made in. In some implementations stateful classifier 146 may implement a Markov model, a Kalman filter, or other suitable constructions.

A single stateless classifier 142 and stateless classifier set 144 may also provide their output to stateful smoothers 148a and 148b, respectively. A stateful smoother 148 performs smoothing operations on the output of a stateless classifier to reduce the effect of outliers on the ultimate determination of the location of mobile device 104. In some implementations, a stateful smoother 148 may simply generate a rolling average of the output of a stateless classifier. The output of orientation evidence generator 138, movement evidence generator 140, single stateless classifier 142, stateless classifier set 144, stateful classifier 148, and stateful smoothers 148a and 148b are all provided to evaluator 150 as inputs for generating a world view 152.

Evaluator 150 compares and combines estimates of where mobile device 104 generated a set of measurements and other related information to create a refined estimate of which zones mobile device 104 generated sets of measurements in. Evaluator 150 may compare zone estimates generated by single stateless classifier sets 142, stateless classifier sets 144, stateful classifier 146, and stateful smoothers 148 to generate an initial set of probabilities describing where mobile device 104 likely generated a corresponding set of measurements. Each probability in such a set of probabilities corresponds to a zone of the indoor area. Evaluator 150 may generate initial sets of probabilities based on a weighted average of probabilities generated by inputs to evaluator 150, with weights assigned to inputs based on how reliably the input indicates which zone a set of measurements was made in. As an illustrative example of such a function, evaluator 150 may receive probabilities that a set of measurements was made in different zones as inputs, multiply each received probability by the weight assigned to the input that generated the probability, add the weighted probabilities for each zone, and divide by the weighted sum of all probabilities received for all zones. Evaluator 150 may store such initial sets of probabilities in world view 152.

Evaluator 150 may also modify sets of probabilities based on information stored in world view 152, on subsequent sets of measurements, or other suitable information. Information stored in world view 152 may indicate that subsequent measurements are more or less likely to be in a particular zone. As an illustrative example, if orientation evidence generator 138 and movement evidence generator 140 indicate that a set of measurements was made within three feet of the immediately preceding measurement, evaluator 150 may modify the initial set of probabilities associated with the set of measurements to reflect that mobile device 104 generated the set of measurements in the vicinity of where it generated the preceding set of measurements. Subsequent sets of measurements may likewise allow evaluator 150 to modify a set of probabilities associated with an earlier measurement. As an illustrative example, if an initial set of measurements is consistent with a first zone of an indoor area, but a second set of measurements generated five seconds later must have been made at least five hundred feet from the first zone, evaluator 150 may modify the set of probabilities associated with the initial set of measurements to reduce or eliminate the probability that mobile device 104 generated the initial set in the first zone. In some implementations, evaluator 150 may combine the information provided by orientation evidence generator 138 and movement evidence generator 140 to identify a route traveled by mobile device 104, and may further compare the identified route to a map of the indoor area to determine which zones mobile device 104 was located in and the zone in which it is located at the time it generates the next set of measurements. In an embodiment, a route may comprise a sequence of zones, such as a set of zones in which a mobile device 104 was located at various times and an order in which the mobile device 104 traveled through the each of the zones in the set of zones. Modifications of a set of probabilities, whether based on information stored in world view 152, on subsequent sets of measurements, or some other factor, may be made based on the Bayesian formula or on some other suitable basis.

World view 152 is a computer-readable and -writable medium representing a set of hypotheses of the location of mobile device 104 in the past and present. When a first measurement is taken, the world view 152 may include several possible zones in which the first measurement may have been made; as more measurements are taken that confirm or contradict hypotheses regarding where the first measurement was taken, the hypotheses regarding the first measurement in world view 152 may be changed, with more likely hypotheses being weighted more heavily and impossible hypotheses being discarded. As more measurements are generated and processed, world view 152 may indicate that mobile device 104 has taken a definite path through an indoor area and consequently allow evaluator 150 to specify which zone a future set of measurements was generated in.

### Locational Devices

FIG. 2A is an illustrative block diagram of a mobile locational device 200, which may act as mobile device 104 of FIG. 1A-C. A mobile locational device 200 may be a cellular phone, a smartphone, a tablet computer, or some other device capable of measuring available signals and transmitting measurements. A mobile locational device 200 may comprise a plurality of connected devices, all associated with a user. In an example, a mobile locational device 200 may comprise a watch in communication with another device. In another example, a mobile locational device 200 may comprise an external source of data, such as a pedometer or heart rate monitor, in communication with another device. The measurements generated may be used to identify the location of mobile locational device 200, and mobile locational device 200 may be provided with content or instructions based on its location. Mobile locational device 200 transmits and receives data through communication port 202. Communication processor 204 may receive instructions from and transmits information to location server 110 via communication port 202 and network 108. Sensor package 206 includes one or more sensors generating data related to the location of mobile locational device 200, which measurement processor 208 includes in a measurement package for transmission to location server 110. Such measurement packages may also include information stored in identification database 210 that identifies mobile locational device 200. User interface (UI) 212 may provide information to a user based on information received from location server 110, which may include ringing, vibrating, displaying content on a display, or otherwise providing a signal to the user.

The depicted communication port 202 is a network port that transmits location-related information to and receives information from location server 110 via network 108. Communication port 202 may include a WI-FI antenna, a cellular antenna, or other suitable receivers and transmitters. In certain implementations, there may be a different number of ports than are depicted: as an illustrative example, a mobile locational device 200 may include both a cellular antenna and a WI-FI antenna. In certain implementations, communication port 202 may provide secure communications, such as by using the Secure Sockets Layer (SSL) protocol, the Transport Layer Security (TLS) protocol, or other suitable protocol.

The depicted communications processor 204 is a computer processor for connecting to a location server 110 over network 108 in order to transmit data to and receive data from the location server 110. In some implementations, communications processor 204 may transmit and receive data using a secure network connection, such as a connection made using the SSL or TLS protocols. In response to instructions received from measurement processor 208, communication processor 204 may transmit a measurement package to location server 110. Such a measurement package may include identification data from identification database 210 and measurement data associated with sensor package 206. Communication processor 204 may receive instructions from location server 110 regarding whether to provide measurement packages, what to include in measurement packages, how frequently to provide measurement packages, what information to provide to a user, or other suitable instructions. Communication processor 204 may transmit such instructions to measurement processor 208 or UI 212 as appropriate. In some implementations, communication processor 204 may also request data from location server 110 in response to a user request made through UI 212.

The depicted sensor package 206 includes one or more sensors for measuring signals that may be associated with a location. Such signals may include wireless computer signals, magnetic fields, navigational satellite signals, radio frequency signals, sounds audible to humans, sounds inaudible to humans, visual signals, infrared (IR) signals, ultraviolet (UV) signals, movement signals, barometric signals, temperature signals, or other suitable signals. To measure one or more such signals, sensor package 206 may include one or more of a radio-frequency receiver, a magnetic field measurement device, a microphone, a digital camera, a charge-coupled device, a video recorder, a photodiode, a photodetector, an accelerometer, a gyroscope, a pressure sensor, a temperature sensor, a heart rate monitor, a respiratory rate monitor, a pedometer, or some other suitable measurement device. In some implementations, sensor package 206 may include or be comprised of communication port 202 and communication processor 204. In such implementations, information regarding WI-FI signals, BLUETOOTH signals, cellular network signals, or other suitable signals may be used in identifying a zone in which mobile locational device 200 is located. In some such implementations, such locational information may be identified whether or not the associated signals are also used to connect mobile locational device 200 to network 108. In some implementations, sensor package 206 includes a receiver capable of receiving navigational satellite signals, which may include signals from the Global Positioning System (GPS), the Global Navigation Satellite System (GLONASS), or other suitable satellite navigational systems.

The depicted measurement processor 208 is a computer processor for generating measurement packages. Measurement processor 208 may generate measurement packages according to predetermined criteria, which may include whether a user is running an application on mobile locational device 200, whether the output of sensor package 206 is consistent with mobile locational device 200 being located within a predetermined indoor area, reception of a request for a measurement package from location server 110, or other suitable criteria. Measurement packages provide information that may be used to associate mobile locational device 200 with a zone of an indoor area, and may include information identifying mobile locational device 200 and information regarding the location of mobile locational device 200. Information identifying mobile locational device 200 may include the make and model of mobile locational device 200, the operating system of mobile locational device 200, information identifying the sensors in sensor package 206, a device identification of mobile locational device 200, identification of a user associated with mobile locational device 200, or other suitable information. Information regarding the location of mobile locational device 200 may include a measurement of one or more signals by sensor package 206, information derived from a measurement of one or more signals by sensor package 206, a time at which a measurement was made, or other suitable information. In some implementations, a measurement package may not include information corresponding to each signal sensor package 206 is capable of measuring. For each signal measured by sensor package 206 that is a basis for a measurement package, measurement processor 208 may include the measurement of the signal itself, information derived from such a measurement, or both. A measurement of the strength and orientation of a magnetic field is an illustrative example of a measurement of a signal; a displacement of the device calculated based on accelerometer output is an illustrative example of information derived from a measurement. In some implementations, measurement processor 208 may calibrate the output of a magnetometer based on a series of magnetic field measurements, allowing for the measurement of both magnetic fields arising from objects in the indoor area and the Earth's magnetic field. In some such implementations, the parameters of the magnetometer calibration are included in measurement packages, which may be used to identify a distinct zone of an indoor area associated with the calibration parameters, to identify movement through a zone according to a known profile of calibration parameter variation, or may otherwise be used to identify a location of mobile locational device 200. In some implementations, measurement processor 208 may clean, filter, smooth, or otherwise adjust measurements or measurement information.

In an embodiment, the measurement processor 208 may generate measurement packages based on physiological data of a user of mobile locational device 200. Such physiological data may include heart rate, respiration rate, blood pressure, and other data which may be measured by sensor package 206. Measurement packages based on physiological data may provide information or estimates regarding: state of mind of the user; level of interest; level of alertness; walking speed; length of time spent standing still; and length of time spent walking. As an illustrative example, a determination that a user's heart rate increased when in a particular zone of a store may indicate an increased level of interest in merchandise in that zone. As another illustrative example, a determination that a user's heart rate increased despite standing still for an extended period of time within a zone of a store may indicate that the increased heart rate was not due to a high level of activity, reinforcing an estimate that the user has an increased level of interest in merchandise in the zone. As another illustrative example, a determination that a user did not stand still in a particular zone of a store may indicate that the user was not interested in merchandise in the zone. These and other similar estimates may be performed based on physiological data and information derived therefrom. In an embodiment, such estimates may be used to direct advertising content, promotional content, or sales staff to the user of the mobile locational device.

Identification database 210 may be a computer-readable and -writable medium for storing information about the mobile locational device 200, the user of the mobile locational device 200, or other suitable identifying information. Information about the mobile locational device 200 may include the device manufacturer, the device model, the operative firmware, a list of sensing capabilities, calibrations of sensors in sensor package 206, accuracies of sensors in sensor package 206, or other suitable information. Information about the user of the mobile locational device 200 may include a username, an account history, a rewards balance, or other suitable information. In some implementations, a user of the mobile locational device 200 may choose to disable the transmission of a portion of the identification information stored in identification database 210.

UI 212 is an interface through which a user may receive content associated with a location. UI 212 may include an output device, such as a display or a speaker, which provides information received from location server 110 to the user. In some implementations, UI 212 also allows a user to generate requests using a cursor, a touchscreen, a microphone, or some other suitable input device. In such implementations, measurement processor 208 may generate measurement packages based at least in part on user input, and the content provided to the user through UI 212 may also vary based on user input. As an illustrative example of such implementations, if a user searches for a particular product in a store, UI 212 may display a map from the zone in which the user is located to the zone in which the product is located. Requests may include requests for content associated with a location, requests for assistance at a location, and other suitable requests.

FIG. 2B is an illustrative block diagram of a location server 230, which may act as location server 110 of FIG. 1B. Location server 230 includes a communications port 232 connecting location server 230 to network 108. Communications processor 234 identifies and directs incoming and outgoing network traffic, including measurement packages received from and content transmitted to mobile locational devices 200. Communications processor 234 forwards measurement packets to location processor 236. Location processor 236 may interpret the measurement packet using rules stored in location database 238 to calculate the probability that mobile device 104 generated the measurement packet in a zone of an indoor area. Location processor 236 may store calculated probabilities in location database 238, and may revise such probabilities based on previously calculated probabilities, subsequent measurement packages, or other suitable information. Zone content database 240 stores content or instructions associated with zones of the indoor area, and location processor 236 may carry out such instructions or provide stored content to mobile device 104 based on the probability that the mobile device 104 is or was within a given zone. The rules stored in location database 238 may be based on raw training data provided by communications processor 234 to data pre-processing engine 242. As described in relation to FIG. 7, raw training data consists of a measurement package that is known to be associated with a zone 112. Data pre-processing engine 242 may identify the zone 112 associated with an element of raw training data using information stored in training identification database 244 and divide the raw training data into a training data set and a test data set. Data pre-processing engine 242 may also store measurement packages from the raw training data and their associated zones in training database 246. As depicted, the training data set may be provided to neural network development engine 248, which may identify rules for classifying a mobile locational device 200 as being in one or another zone 112. Neural network test engine 250 uses the test data to determine the validity of the rules identified by neural network development engine 248.

The depicted communication ports 232 is a network port, and may include 100BASE-TX Ethernet ports, 1000BASE-T Ethernet ports, 10GBASE-T Ethernet ports, a WI-FI antenna, or other suitable network ports. Communication port 232 may transmit data received from network 108 to communications processor 234, and may transmit data to a mobile locational device 200 via network 108. In some implementations, there may be a different number of communication ports 232 than are depicted.

Communications processor 234 may be a computer processor that sends data to and receives data from a mobile locational device 200. Communications processor 234 may receive a measurement package from a mobile locational device 200, identify whether the measurement package is raw training data to be sent to data pre-processing engine 242 or location data to be transmitted to location processor 236, and transmit the measurement package accordingly. Communications processor 234 may further transmit instructions to a mobile locational device 200 regarding what to include in measurement packages sent by the device 200 and how often to send the packages, and may also or alternatively transmit content associated with the zone of the device 200. In some implementations, a service administrator may provide instructions to location server 230 via communications processor 234. As an illustrative example of such implementations, a service administrator may change the required accuracy for location identification, identify a new zone to be distinguished from the rest of an indoor area, or alter the content associated with a zone.

Location processor 236 may be a computer processor for identifying probabilities that mobile locational device 200 is or was located in one or another zone at the time it generated a measurement package. As described in relation to FIG. 4A, location processor 236 may identify the indoor area in which the mobile locational device 200. As described in relation to FIGS. 1D and 4B, location processor 236 may calculate a set of probabilities describing in which zone of the indoor area the device 200 may have generated a measurement package. The probability calculation may be based on measurement and identification data in the measurement package, rules recorded in location database 238, sets of probabilities describing where previously gathered measurement packages were generated, models of user behavior, or other suitable criteria. Location processor 236 may use one or more of neural networks, Bayesian models, Kalman filters, Markov models, or other suitable techniques to calculate a set of probabilities describing in which zone device 200 may have generated a measurement package. As an illustrative example, location processor 236 may implement single stateless classifiers 142 and stateless classifier sets 144 as neural networks, stateful classifier set 146 as a Markov model, and stateful smoothers 148 as Kalman filters, while evaluator 150 may use the results of such implementations to update a Bayesian model of the position of mobile locational device 200. Location processor 236 may store calculated probabilities in location database 238, and may revise such probabilities based on subsequent measurement packages.

In response to determining that a device 200 generated a measurement package in a particular zone of the indoor area, location processor 236 may take an action associated with the zone in accord with instructions recorded in zone content database 240. An action associated with a zone may include instructing communications processor 234 to transmit content or measurement instructions to the mobile location device 200. In some implementations, location processor 236 may also or alternatively record information regarding the classification of a mobile locational device 200, such as when and for how long a particular mobile locational device 200 was in a particular area. In some implementations, location processor 236 may also predict where a mobile locational device 200 will be located or a route it will follow, such as by comparing the motion of the mobile locational device 200 to previous routes taken by the same or other mobile locational devices 200. In some implementations, location processor 236 may take actions based on a predicted mobile location.

Location database 238 may be a computer-readable and -writable medium that stores sets of probabilities describing where a mobile locational device 200 may have generated measurement packages and rules for calculating such sets of probabilities. Sets of probabilities may be generated and modified by location processor 236. Rules for calculating sets of probabilities may include rules for converting location and orientation data into routes followed by a mobile locational device 200, maps of the indoor area indicating allowed transitions between zones, classification rules for determining whether a measurement package may have been generated within a particular zone, classifier weightings indicating the probability that a measurement package that a classifier indicates may have been generated in a particular zone was actually generated in the particular zone, and other suitable rules. In some implementations, location database 238 also stores a model of the likelihood that a mobile locational device 200 will be moved from one zone to another zone, as described in relation to FIG. 5C. Classification rules may be generated by neural network development engine 248, and may in some implementations be revised over time. Classifier weightings may be revised by location processor 236 over time. Location database 238 may record classification rules for more than one indoor area, in which case a single classifier may be associated with only one indoor area or with multiple indoor areas.

Zone content database 240 may be a computer-readable and -writable medium storing rules associating content or instructions with a zone 112. As an illustrative example of the former, zone content database 240 may associate a zone in a museum that includes a T. rex fossil with a video rendering of the dinosaur such that the video may be transmitted to a mobile locational device 200 identified as being located in the zone. As an illustrative example of the latter, zone content database 240 may associate a large zone that a user carrying a mobile locational device 200 is unlikely to leave rapidly with instructions to transmit measurement packages less frequently, allowing the mobile locational device 200 to save energy. In some implementations, zone content database 240 may indicate that other devices should be signaled in response to a mobile locational device 200 being within a zone 112. Illustrative examples of such implementations include instructing a third party to move to the designated zone and changing the output of an air conditioning unit based on the number of mobile locational devices 200 located within the designated zone.

Data pre-processing engine 242 may be a computer processor for preparing raw training data for developing rules associating measurement packages with zones and for providing content associated with a zone 112. Raw training data may be received from a mobile locational device 200 via communications processor 234, and includes a measurement package. Using information stored in training identification database 244, data pre-processing engine 242 may identify with which zone 112 an element of raw training data is associated. The processed raw training data may be stored in training database 246, and may be divided into training data provided to neural network development engine 248 and test data provided to neural network test engine 250. The raw training data may be divided randomly or using some other appropriate scheme.

Training identification database 244 may be a computer-readable and -writable medium storing information identifying a zone 112 associated with an element of raw training data. An element of raw training data is associated with a zone 112, which may include a measurement package including information identifying zone 112 or a system administrator indicating that a measurement package is raw training data associated with a zone 112. In some implementations, a service administrator may alter training identification database 244, such as by changing zones, changing content associated with zones, or making some other suitable changes.

Training database 246 may be a computer-readable and -writable medium storing measurement packages and indicating each measurement package's associated location or zone 112. Data stored in training database 246 may be used to develop and test rules stored in location database 238 for calculating a probability that a measurement package was generated in a zone. In some implementations, training data stored in training database 246 may be replaced with new training data based on the time elapsed since the replaced data was taken, whether the new training data was taken at a similar time of day or with a similar device as the replaced data, or some other suitable criteria.

Neural network development engine 248 may be a computer processor for training a neural network to classify measurement data. Neural network development engine 248 may provide measurement packages from the training data to an existing or randomly generated neural network and compare the resulting classifications with the zones identified in the training data. The neural network may then be adjusted to reduce the error rate, and the process repeated until a predetermined error rate is achieved, as described in relation to FIG. 7. Neural network development engine 248 may use the backpropagation algorithm or some other suitable algorithm to train neural networks. In some implementations, some of the training data may be designated as validation data. In such implementations, the neural network's rate of errors in correctly classifying the validation data is examined as the neural network is trained, and if the error changes in a predetermined fashion the training may be stopped. In implementations in which a neural network is not used to classify measurement data, neural network development engine 248 may instead generate a model used to classify measurement data. In some implementations, the functions of neural network development engine 248 may be carried out by location processor 236.

Neural network test engine 250 may be a computer processor for testing a neural network trained by neural network development engine 248. Neural network test engine 250 receives test data from data pre-processing engine 242, and may determine the proportion of measurement packages in the test data that a neural network generated by neural network development engine 248 will classify correctly. If the proportion falls below a predetermined threshold, neural network test engine 250 may instruct neural network development engine 248 to replace the neural network, possibly with a neural network with a different number of nodes, and may also or alternatively instruct data pre-processing engine 242 to redistribute the raw training data into training data and test data. In implementations in which a neural network is not used to classify measurement data, neural network test engine 250 may instead test some other model used to classify measurement data. In some implementations, the functions of neural network test engine 250 may be carried out by location processor 236. In some implementations, location processor 236 may not use any neural networks in calculating the probability that device 200 generated a measurement package in a zone of the indoor area; in such implementations, location server 230 may not include a neural network development engine 248, or a neural network test engine 250.

Location server 230 develops and implements rules for classifying a mobile locational device 200 as being in one or another zone of an indoor area. Rules may be developed using raw training data from devices 200. Communications processor 234 receives the raw training data and forwards it to data pre-processing engine 242. Data pre-processing engine 242 identifies the zone 112 associated with each raw training data element and assigns each raw training data element to either neural network development engine 248, which uses the data to develop zone classification rules, or to neural network test engine 250, which uses the data to test the developed rules. Rules meeting predefined criteria are saved in location database 238, where they are used by location processor 236 to classify location data from a mobile locational device 200. In response to classifying the device 200 as being in a zone 112, location processor 236 implements one or more rules associated with the zone 112 and stored in zone content database 240.

### Computing Device

FIG. 3 is a block diagram of a computing device that can be used to implement or support the any of the components of the system of FIG. 1B or 2, and for performing any of the processes described herein. Location server 230 may be implemented on one or more computing devices 300 having suitable circuitry, and mobile locational device 200 may communicate with location server 230 through one or more computing devices 300 having suitable circuitry. In certain aspects, a plurality of the components of system 120 may be included within one computing device 300. In certain implementations, a component and a storage device may be implemented across several computing devices 300.

The computing device 300 comprises at least one communications interface unit, an input/output controller 310, system memory, and one or more data storage devices. This can support a network connection such as a connection to network 108 in FIG. 1B. The system memory includes at least one random access memory (RAM 302) and at least one read-only memory (ROM 304). The memory 304 can support the location database 238 of FIG. 2B, for example. All of these elements are in communication with a central processing unit (CPU 306) to facilitate the operation of the computing device 300. The computing device 300 may be configured in many different ways. For example, the computing device 300 may be a conventional standalone computer or alternatively, the functions of computing device 300 may be distributed across multiple computer systems and architectures. In FIG. 3, the computing device 300 may be linked, via network or local network, to other servers or systems.

The computing device 300 may be configured in a distributed architecture, wherein databases and processors are housed in separate units or locations. Some units perform primary processing functions and contain at a minimum a general controller or a processor and a system memory. In distributed architecture implementations, each of these units may be attached via the communications interface unit 308 to a communications hub or port (not shown) that serves as a primary communication link with other servers, client or user computers and other related devices. The communications hub or port may have minimal processing capability itself, serving primarily as a communications router. A variety of communications protocols may be part of the system, including, but not limited to: Ethernet, SAP, SAS™, ATP, BLUETOOTH™, GSM and TCP/IP.

The CPU 306 comprises a processor, such as one or more conventional microprocessors and one or more supplementary co-processors such as math co-processors for offloading workload from the CPU 306. CPU 306 The CPU 306 is in communication with the communications interface unit 308 and the input/output controller 310, through which the CPU 306 communicates with other devices such as other servers, user terminals, or devices. The communications interface unit 308 and the input/output controller 310 may include multiple communication channels for simultaneous communication with, for example, other processors, servers or client terminals.

The CPU 306 is also in communication with the data storage device. The data storage device may comprise an appropriate combination of magnetic, optical or semiconductor memory, and may include, for example, RAM 302, ROM 304, flash drive, an optical disc such as a compact disc or a hard disk or drive. The CPU 306 and the data storage device each may be, for example, located entirely within a single computer or other computing device; or connected to each other by a communication medium, such as a USB port, serial port cable, a coaxial cable, an Ethernet cable, a telephone line, a radio frequency transceiver or other similar wireless or wired medium or combination of the foregoing. For example, the CPU 306 may be connected to the data storage device via the communications interface unit 308. The CPU 306 may be configured to perform one or more particular processing functions.

The data storage device may store, for example, (i) an operating system 312 for the computing device 300; (ii) one or more applications 314 (e.g., computer program code or a computer program product) adapted to direct the CPU 306 in accordance with the systems and methods described here, and particularly in accordance with the processes described in detail with regard to the CPU 306; or (iii) database(s) 316 adapted to store information that may be utilized to store information required by the program. The depicted database 316 can be any suitable database system, including the commercially available Microsoft Access database, and can be a local or distributed database system. The design and development of suitable database systems are described in McGovern et al., A Guide To Sybase and SQL Server, Addison-Wesley (1993).

The operating system 312 and applications 314 may be stored, for example, in a compressed, an uncompiled and an encrypted format, and may include computer program code. The instructions of the program may be read into a main memory of the processor from a computer-readable medium other than the data storage device, such as from the ROM 304 or from the RAM 302. While execution of sequences of instructions in the program causes the CPU 306 to perform the process steps described herein, hard-wired circuitry may be used in place of, or in combination with, software instructions for implementation of the processes of the present disclosure. Thus, the systems and methods described are not limited to any specific combination of hardware and software.

Suitable computer program code may be provided for performing one or more functions in relation to providing content to an audience as described herein. The program also may include program elements such as an operating system 312, a database management system and “device drivers” that allow the processor to interface with computer peripheral devices (e.g., a video display, a keyboard, a computer mouse, etc.) via the input/output controller 310.

The term “computer-readable medium” as used herein refers to any non-transitory medium that provides or participates in providing instructions to the processor of the computing device 300 (or any other processor of a device described herein) for execution. Such a medium may take many forms, including but not limited to, non-volatile media and volatile media. Non-volatile media include, for example, optical, magnetic, or opto-magnetic disks, or integrated circuit memory, such as flash memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other non-transitory medium from which a computer can read.

Various forms of computer readable media may be involved in carrying one or more sequences of one or more instructions to the CPU 306 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device 300 (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

As discussed above, a function relating to identifying a location can be realized as a software component operating on a conventional data processing system such as a Unix workstation. In that implementation, the function can be implemented as a C language computer program, or a computer program written in any high level language including C++, Fortran, Java or BASIC. See The C++ Programming Language, 2nd Ed., Stroustrup Addision-Wesley. Additionally, in an implementation where microcontrollers or DSPs are employed, the function relating to identifying a location can be realized as a computer program written in microcode or written in a high level language and compiled down to microcode that can be executed on the platform employed. The development of such network traffic control systems is known to those of skill in the art, and such techniques are set forth in Digital Signal Processing Applications with the TMS320 Family, Volumes I, II, and III, Texas Instruments (1990). Additionally, general techniques for high level programming are known, and set forth in, for example, Stephen G. Kochan, Programming in C, Hayden Publishing. Developing code for the DSP and microcontroller systems follows from principles well known in the art.

Some implementations of the above described may be conveniently implemented using a conventional general purpose or a specialized digital computer or microprocessor programmed according to the teachings herein, as will be apparent to those skilled in the computer art. Appropriate software coding may be prepared by programmers based on the teachings herein, as will be apparent to those skilled in the software art. Some implementations may also be implemented by the preparation of application-specific integrated circuits or by interconnecting an appropriate network of conventional component circuits, as will be readily apparent to those skilled in the art. Those of skill in the art would understand that information and signals may be represented using any of a variety of different technologies and techniques. For example, data, instructions, requests, information, signals, bits, symbols, and chips that may be referenced throughout the above description may be represented by voltages, currents, electromagnetic waves, magnetic fields or particles, optical fields or particles, or any combination thereof.

Some implementations include a computer program product comprising a computer readable medium (media) having instructions stored thereon/in and, when executed (e.g., by a processor), perform methods, techniques, or implementations described herein, the computer readable medium comprising sets of instructions for performing various steps of the methods, techniques, or implementations described herein. The computer readable medium may comprise a storage medium having instructions stored thereon/in which may be used to control, or cause, a computer to perform any of the processes of an implementation. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in. Additionally, the storage medium may be a hybrid system that stored data across different types of media, such as flash media and disc media. Optionally, the different media may be organized into a hybrid storage aggregate. In some implementations different media types may be prioritized over other media types, such as the flash media may be prioritized to store data or supply data ahead of hard disk storage media or different workloads may be supported by different media types, optionally based on characteristics of the respective workloads. Additionally, the system may be organized into modules and supported on blades configured to carry out the storage operations described herein.

Stored on any one of the computer readable medium (media), some implementations include software instructions for controlling both the hardware of the general purpose or specialized computer or microprocessor, and for enabling the computer or microprocessor to interact with a human user and/or other mechanism using the results of an implementation. Such software may include without limitation device drivers, operating systems, and user applications. Ultimately, such computer readable media further includes software instructions for performing implementations described herein. Included in the programming (software) of the general-purpose/specialized computer or microprocessor are software modules for implementing some implementations.

### Indoor Location Identification

FIG. 4A is an illustrative flow chart of general location identification process 400. Referring to FIG. 2A, general location identification process 400 determines whether a mobile locational device 200 is in an indoor area like that depicted in FIG. 1C. If so, general location identification process 400 calls upon indoor location identification process 410, as described in relation to FIG. 4B, to identify a zone associated with the mobile locational device 200.

General location identification process 400 may begin when a location identification application is run on a mobile locational device 200 in step 401. Such a location identification application may run automatically while the mobile locational device 200 is turned on, or may only be run in response to a user command. In step 402, either measurement processor 208 or location server 110 determines whether a predetermined set of measurement data falls within a predetermined range. As an illustrative example, the output of a GPS receiver in sensor package 206 may be transmitted to measurement processor 208 or to location server 110 to determine if the output corresponds to a building in which indoor location services are available. As an illustrative example, the determination of step 402 may be based on one or more of: the heuristic analysis of measured signals; the presence or absence of communication with cellular telephone transmitters; location estimates derived from geofencing; location estimates performed on the mobile locational device 200; prior information regarding the location of mobile locational device 200; audio data; video data; gyroscope data; predictions of the location of mobile locational device 200; physiological measured data such as heart rate data; data which may be obtained from one or more sensor packages described herein; and other data which may be used to estimate a location. Step 402 may be repeated until the mobile locational device 200 is within an appropriate area. Some implementations may omit step 402.

Once the mobile locational device 200 is in the indoor area for which indoor location services are being provided, step 403 instructs the device to provide a measurement package to location server 110. Like step 402, step 403 may be carried out by measurement processor 208 or by location server 110. In some implementations, step 403 may be carried out in response to a user interaction with UI 212, such as a user request for directions or for information regarding a display. Such measurement packages may include one or more measurements associated with sensor package 206 and identification information from identification database 210. Measurements may include magnetic field strength and direction measurements, the names and signal strengths of detectable WI-FI networks, the names and signal strengths of detectable BLUETOOTH devices, a location identified using GPS, a displacement of the device since a previous measurement package was transmitted derived from accelerometer data, barometric data, temperature data, or other suitable information. In some implementations, a measurement in a measurement package may represent an average of several base measurements. Identification information may include the device manufacturer, the device model, the operative firmware, a device serial number, a media access control (MAC) address of the device, a list of sensing capabilities, calibrations of the sensors that generated the included measurements, accuracies of the sensors that generated the included measurements, a user account associated with the device, or other suitable information.

In some implementations, the instruction of step 403 will specify which measurements and identification information to include. In some implementations, mobile locational device 200 may be instructed to include less identification information in some measurement packages than in others. In some such implementations, identification information included in one measurement package may be assumed to apply to future measurement packages received from the same network address.

In some implementations, step 403 may be repeated on an interval, which may or may not be fixed. As an illustrative example of such an implementation, location processor 236 may instruct measurement processor 208 to generate measurement packages once every five seconds when the mobile locational device 200 is located within one zone, but once every ten milliseconds when the mobile locational device 200 is located within a different zone. The length of the interval may be a function of the identification information of the mobile locational device 200, the area in which location services are being provided, or other suitable criteria, and may vary from measurement packages being provided as often as possible to being provided less than once an hour. In some implementations, step 403 may be performed in response to a signal, which may include a request from a location server 230, a determination based on accelerometer data that the mobile locational device 200 has been displaced by a threshold amount, or some other suitable signal.

Step 403 may be followed by indoor location identification process 410, described in relation to FIG. 4B. Indoor location identification process 410 may be followed by step 404, in which measurement processor 208 or location server 110 may determine whether the mobile locational device 200 is still within the predetermined range of step 402. Step 404 may be prompted by identifying a location during indoor location identification process 410 or may occur in parallel with indoor location process 410, whether through continuous measurements or measurements taken at periodic intervals. If step 404 indicates that the mobile locational device 200 is still within the predetermined range, indoor location identification process 410 may continue. Otherwise, in step 405 the mobile locational device stops taking the data required by indoor location identification process 410 and returns to step 402. General location identification process 400 may repeat for as long as the location application is running.

FIG. 4B is an illustrative flow chart of indoor location identification process 410. Referring to FIG. 1C, process 410 determines whether the measurement package generated in response to step 403 corresponds to a zone 112. Referring to FIG. 2B, process 410 begins with step 411, in which communication processor 234 receives a measurement package. In step 412, communication processor 234 extracts identification and measurement information from the measurement package. Communication processor 234 may then forward such extracted information to location processor 236 for processing in step 413.

In step 413, location processor 236 processes the information in the measurement package to generate evidence of which zone the measurement package was generated in. Referring to FIG. 1D, location processor 236 may implement step 413 by generating the outputs of one or more of an orientation evidence generator 138, a movement evidence generator 140, one or more single stateless classifiers 142, a stateless classifier set 144, stateful classifier 146, stateful smoothers 148, or other suitable classifiers. Classifiers may be a neural network, such as is described in relation to FIG. 4C, a Kalman filter, a Markov model, a Bayesian model, or some other suitable function. In some implementations, one or more classifier outputs may be generated by a mobile device 104 and included within the measurement package, in which case location processor 236 may simply identify such evidence. As an illustrative example of such implementations, a measurement package may indicate a path traveled by a mobile device 104 since it last generated a measurement package, rather than providing raw accelerometer data.

In step 414, location processor 236 balances the evidence generated or identified in step 413 to calculate a set of probabilities, with each probability in the set indicating the likelihood that the measurement package was generated in a corresponding zone of the indoor area. Referring to FIG. 1D, location processor 236 may act as evaluator 150 in carrying out step 414. The probabilities may be calculated based on the output of classifiers implemented in step 413 and on a confidence in the classifier. Probabilities may be calculated as a function of whether a classifier indicates that a measurement package may have been generated in a zone, and a weighting of the classifier. As an illustrative example, consider a measurement package that classifiers find may have been generated in some zones but cannot have been generated in other zones. In a system in which there is one classifier for each zone and each classifier is considered equally accurate, then zero probability may be assigned to those zones in which the measurement package cannot have been generated and an equal probability to all other zones. In a system in which the same classifiers are assigned different weights, or in which there is also a classifier that determines which zone out of several zones the measurement package was generated in, different zones may be assigned higher or lower probabilities accordingly. In some implementations, classifier weightings may be changed based on subsequent calculations. As an illustrative example of such implementations, if a classifier frequently classifies measurement packages as having been potentially generated in an associated zone, and the majority of such measurement packages are subsequently calculated to be associated with different zones, the classifier's weighting may be decreased accordingly. As another illustrative example, if a classifier classifies a measurement package as having been potentially generated in a first associated zone, and the evaluator 150 later determines that the measurement package was instead generated in a second associated zone, the classifier's weighting may be decreased accordingly.

In step 415, location processor 236 determines whether any set of probabilities may be refined. A set of probabilities may be refined on the basis of additional information. As an illustrative example, if a first measurement package may be consistent with either a first or a second zone, and a second measurement package is only consistent with a third zone that is only adjacent to the first zone, the probability that the first measurement package was generated in the first zone may be revised upward. Location processor 236 may perform retrospective probability refinements, such as calculating probabilities based on an earlier probability calculation and based on the probabilities calculated for a later measurement package. Location processor 236 may also or alternatively perform prospective probability refinements, such as refining a set of probabilities associated with a measurement package based on the probabilities calculated for earlier measurement packages. In some implementations, probability refinements are only calculated if a set of probabilities does not identify only one zone in which the associated measurement package may have been generated. If there is no set of probabilities to refine, indoor location identification process 410 may end by proceeding to step 404 of general location identification process 400; otherwise, process 410 may proceed to step 416.

In step 416, location processor 236 refines a set of probabilities. A set of probabilities calculated during a step 413 may be refined based on another set of probabilities associated with a different measurement package, based on a model of user behavior, based on a constraint model of the indoor area, based on statistics of data collected from other users, based on statistics of data collected from the current user, or based on other suitable information. An illustrative example of a constraint model is described in relation to FIGS. 5A-C. As another illustrative example, if a first measurement package may be associated with one of two zones, and a second measurement package can only be associated with the first of the two zones, then the probability that the first measurement package was generated in the first zone may be revised upward—so long as other information does not indicate that the two measurement packages might have been taken in two different zones. To extend the example, to the extent that a person carrying the mobile locational device might have moved from one zone to the other during the period between when the first measurement package was recorded and when the second measurement package was recorded, the set of probabilities of the first measurement package may not be refined. Sets of probabilities may be refined based on Bayesian models, hidden Markov models, or using other suitable models. In some implementations, if a probability associated with a classifier is consistently refined upward or downward, location processor 236 may adjust the classifier's weighting accordingly, may generate a message to a system administrator to generate a new set of training data, or may otherwise act to improve the accuracy of the classifier.

In some implementations, accelerometer data may be used to refine probabilities. As an illustrative example of such implementations, if accelerometer data indicates that a mobile locational device 200 traveled a distance of thirty meters to the east during the time when a first measurement package was taken and the time a second measurement package was taken, then the second measurement package must have been taken in a zone thirty meters to the east of one of the possible zones in which the first measurement package was generated, and vice-versa.

In step 417, location processor 236 determines whether a refined probability associated with a zone is greater than a threshold, indicating that the measurement package associated with the probability was generated in the zone. If not—if a measurement package still cannot be said with sufficient certainty to have been generated in a particular zone—process 410 may then proceed to step 404 of process 400. Otherwise, the measurement package on which the unrefined set of probabilities was based may be considered to have been generated in the zone, and location processor 236 may perform an action associated with the zone in step 418. Such actions may include transmitting content to the mobile locational device 200, recording the zone as a step along the path traveled by the mobile locational device 200, transmitting instructions to the mobile locational device 200 to change the criteria used to determine whether to generate a measurement package, or other suitable actions. In some implementations, the action taken in step 418 is only made when the probability that device 200 generated a measurement package in a particular zone first exceeds the threshold. In some implementations, a different action may be taken if subsequent refinements to the set of probabilities cause a probability to fall below the threshold. After step 418, process 410 may then proceed to step 404 of process 400.

FIG. 4C depicts an exemplary neural network 420 for classifying an indoor location, such as the neural networks mentioned in relation to FIGS. 2B and 4B. Neural network 420 takes measurements 422a-f (collectively, measurements 422) as inputs for nodes 424a-f (collectively, nodes 424). Nodes 424 are inputs for hidden nodes 426a-f, which are themselves inputs for hidden nodes 426g-k. Hidden nodes 426g-k are inputs for outputs 428a-d (collectively, outputs 428). Thus, neural network 420 generates outputs 428 in response to receiving a set of measurements 422.

Referring to FIG. 2A, a measurement 422 may include the type of mobile locational device 200 generating measurements 422, a geographic location estimated by external location processor 216, raw GPS measurements from GPS sensor 202, a signal strength of a predetermined WI-FI network as detected by WI-FI antenna 204, the signal strength of a predetermined BLUETOOTH device as detected by BLUETOOTH antenna 206, magnetic field strength and direction measurements from magnetic sensor 208, measurements of the strength and frequency of audio signals from microphone 210, the wavelength and intensity of ambient light detected by camera 212, the pressure recorded by a barometric sensor, the temperature recorded by a temperature sensor, or other suitable data. In some implementations, there may be a different number of measurements 422 than are here depicted. In some implementations, more than one measurement 422 may be related to the same type of measurement unit of mobile locational device 200. As an illustrative example of such implementations, measurement 422c may be the strength of a WI-FI signal “A,” and measurement 422d may be the strength of a WI-FI signal “B.” Each node 424 is a function of an associated measurement 422, and may equal its associated measurement 422. In some implementations, a node 424 may be a function of more than one measurement 422, such as of both the signal strength of a WI-FI network and whether the mobile locational device 200 is of a particular type. In some implementations, there may be a different number of nodes 424 than are here depicted.

Hidden nodes 426a-k, collectively hidden nodes 426, are functions of the nodes to which they are connected to their left on neural network 420. For example, hidden node 426c is a function of nodes 424a-f, and hidden node 426h is a function of hidden nodes 426a-f. In some implementations, there may be a different number of hidden nodes 426 than are depicted. A hidden node 426 may be a function of a weighted sum of its input nodes, where each input node may have a different weight on the output of the hidden node 426. The weights may be altered during network node training, as described in relation to FIG. 5. The function of a hidden node 426 may generate one of a finite set of numbers based on the input, such as equaling −1 when the weighted sum is smaller than a first predetermined value, zero when the weighted sum is greater than the first predetermined value but less than a second predetermined value, and one when the weighted sum is larger than the second predetermined value. In some implementations, the function of a hidden node 426 may generate a number from a continuous set of numbers.

An output 428 is a classification of the measurement package that was input as measurements 422, and thus is a classification of the mobile locational device 200 that generated the measurement package. Referring to FIG. 1C, output 428a may represent the probability that a set of measurements 422 was generated in zone 112a, while output 428b may represent the probability that a set of measurements 422 was generated in zone 112b. In some implementations, an output 428 may indicate that a different neural network should be used for classifying the location of the mobile locational device 200. In such implementations, output 428 may indicate that the mobile locational device 200 should take a different amount of data, which may include taking less data to save energy or more data to more precisely classify the location of mobile locational device 200. In some implementations, there may be a different number of outputs 428 than are depicted. As an illustrative example of such an implementation, each zone may be associated with a neural network 420, and each such neural network 420 may indicate only whether a measurement package is consistent with its associated zone or not.

### Zone Transitions

FIG. 5A is an illustrative block diagram of zones of an indoor area 500 like that depicted in FIG. 1C. As depicted, indoor area 500 includes zones 502-534. Zones 502-534 represent areas in which a mobile device 104 may be located, and a mobile device 104 may only transition between two zones that share a border. Thus, a mobile device 104 located in zone 514 may only enter zone 504 if it passes through either zone 502 or through zones 524, 526, 528, 516, and 506. Similarly, a mobile device 104 may not directly pass from zone 514 to zone 516; in some implementations, a physical barrier may separate zone 514 from zone 516. As depicted, a mobile device 104 must pass through zone 518 in a transition from zone 516 to zone 520 or vice-versa; in some implementations, zone 518 may be a staircase, with zone 516 (and adjacent zones) on one floor and zone 520 (and adjacent zones) on another floor. In some implementations, zones 502-534 may differ in one or more of size, shape, and number than as here depicted. In some implementations, an overall path of a mobile device 104 may be compared to indoor area 500 to determine which zones mobile device 104 passed through and in which order: as an illustrative example, if mobile device 104 travels in an oval loop as wide as the combined with of zones 502, 504, and 506, and as long as the combined length of zones 502, 514, and 524, it cannot have traveled from zone 506 to zone 530 during the course of that loop.

FIG. 5B is an illustrative state transition table 540 recording possible transitions between zones 502-534. Rows of table 540 represent an initial zone 550 in which a mobile device 104 is located, and columns of table 540 represent a destination zone 560 of a possible zone transition by the mobile device 104. Table 540 lists a “1” at the intersection of an initial zone 550 with a destination zone 560 if a transition between the two zones is possible, and nothing otherwise. As an example, table 540 indicates that a transition may be made from zone 502 to zone 504 and vice-versa, but no direct transition can be made between zones 502 and 506. Such information may be used to identify in which zone a mobile device 104 was or is located. As an illustrative example, a mobile device 104 may generate two measurement packages, the first consistent with both zones 502 and 530, and the second consistent with both zones 504 and 524. Although neither measurement package provides enough information to conclusively identify the zone in which it was generated, if the two packages were generated within a period of time only sufficient for the mobile device 104 to have made a transition between two adjacent zones, then table 540 indicates that the first package must have been generated in zone 502 and the second package must have been generated in zone 504. Referring to FIG. 4B, table 540 may be used in step 416 to refine a set of probabilities describing the set of zones consistent with a measurement package. In some implementations, table 540 may also record other constraints on motion: as an illustrative example, if an accelerometer indicates that there is horizontal motion greater than the width of zone 514, table 540 may indicate that such motion is incompatible with mobile device 104 being located in zone 514.

FIG. 5C is an illustrative state transition table 570 recording costs for possible transitions between zones of indoor area 500; for simplicity, only costs for transitions from zones 502-504 to zones 502-514 are depicted. As in FIG. 5B, rows of table 570 represent an initial zone 550 in which a mobile device 104 is located, columns of table 570 represent a destination zone 560 of a possible zone transition by the mobile device 104, and no information is listed for impossible transitions. Unlike table 540, table 570 represents a model in which a mobile device 104 is considered more likely to return to a zone in which it was previously located than to transition to a new zone. As depicted, when a transition is possible, table 570 lists costs c for a potential transition based on a previous zone p in which the mobile device 104 was located, with higher costs indicating a lower likelihood of transition. As an illustrative example, if a mobile device was in zone 502 and is now in zone 504, then p=502 and table 570 indicates that there is a cost c of returning to zone 502 of 1, and a cost c of moving to zone 506 of 2. The table thus indicates that the mobile device is more likely to be back in zone 502 a short time after moving to zone 504 than it is to have moved on to zone 506. The costs represented in table 570 are only examples, and other costs or formulas for costs may be applied or used. As an illustrative example, the cost of a transition may be calculated based on one or more of time spent in a zone, the size of a zone, the shape of a zone, the direction in which the mobile device 104 has been moving, the speed at which the mobile device 104 has been moving, the time between the generation of measurement packages, previous behavior exhibited by the user of the mobile device 104, and other suitable information. In any case the actual model or formula used is not an essential element of the systems and methods described herein, and may vary depending on the area being addressed, the mobile device 104, or upon other facts being addressed. Like table 540, table 570 may be used in step 416 of process 410 to refine a set of probabilities describing the set of zones consistent with a measurement package. Such a recalculation may include both eliminating impossible results, as described in relation to FIG. 5B, and through Bayesian inference or some other suitable modeling regarding where a mobile device 104 has been or is currently located.

### Pattern Identification

FIG. 6 is an illustrative flow chart depicting a pattern identification process 600 for identifying whether a mobile device is following a route. Process 600 may run in parallel with indoor location identification process 410. Referring to FIG. 2B, process 600 may begin when communications processor 234 receives one or more measurement packages in step 601. In step 602, location processor 236 may identify zones of an indoor area in which the measurement packages were generated, such as is described in relation to FIG. 4B. The zones in which the measurement packages were generated comprise a route being followed by the device that generated the measurement packages of step 601. In an embodiment, the route may further comprise an elapsed time associated with each identified zone, thus quantifying the speed of the mobile device's motion. In an embodiment, the route may comprise other motion data associated with the mobile device, and associated with each zone. In this embodiment, the route would comprise not only the elapsed time in each zone, but also duration and frequency of periods of no motion of the mobile device. In step 603, location processor 236 may identify routes recorded in location database 238 that are similar to the route indicated by step 602. Criteria for identifying one route as similar to another may include whether both routes are associated with the same mobile locational device 200, whether both routes started during business hours, whether both routes started at a similar time of day, whether both routes started on similar days of the week or month, if both routes began with and initially traveled through the same or similar sets of zones, or other suitable criteria.

In step 604, location processor 236 may calculate similarity scores between the current route (as identified in step 602) and each of the similar routes identified in step 603. A similarity score between two routes may be calculated using a predetermined function of the time spent in each zone of each route, whether both routes were followed by the same device, the time of day at which each of the two routes began, or other suitable variables. As an illustrative example, in some implementations location processor 236 may calculate a similarity score between a first, ongoing route and a second, previously recorded route by summing the number of zone boundaries between the position of a first device at each second after it began following the first route to the position of a second device at each second after it began following the second route. In such an implementation, the lower the similarity score, the more similar the two routes associated with the similarity score, but in some implementations similarity scores will be higher when routes are more similar.

In step 605, location processor 236 compares one or more similarity scores calculated in step 604 to a threshold. As depicted, step 605 determines whether the similarity score is less than a threshold; in implementations in which higher similarity scores represent more similar routes, step 605 may instead determine whether the similarity score is greater than a threshold. The threshold may be a predetermined number, or may be a function of one or more criteria such as how long the current route has been followed by the device generating the measurement packages of step 601, whether the routes being compared were followed by the same device, whether the routes being compared began at similar times of day, or other suitable criteria. If the similarity score does not meet the threshold, the current route is considered insufficiently similar to other routes to come to a conclusion, and pattern identification process 600 may return to step 601. Otherwise, process 600 may end with location processor 236 may carry out one or more actions associated with the recorded route associated with the similarity score in step 606. Actions associated with the recorded route may include transmitting content to the device following the route, transmitting content to other devices in the indoor area, predicting which zone future measurement packages will be generated in based on the previous route, performing probability refinements, which may comprise prospective or retrospective refinements, or other suitable actions. Referring to FIG. 4B, in implementations in which location processor 236 predicts which zone future measurement packages will be generated in, such predictions may be used to refine sets of probabilities in step 415.

### Neural Network Training

FIG. 7 is an illustrative flow chart depicting a training process 700 for training a neural network to identify a zone of an indoor area based on available measurement data, according to an illustrative implementation. Referring to FIG. 2B, process 700 may be implemented by a location server 230, and a neural network trained by process 700 may be used to classify locations as described in relation to FIG. 4B. Training process 700 begins with step 701, in which communications processor 234 receives raw training measurement packages. Raw training measurement packages are measurement packages such as those described in relation to FIGS. 4A and 4B, but each raw training measurement package is associated with a zone or location within a zone. A raw training measurement package may include information identifying the zone or location with which it is associated, or such information may be provided separately, such as by a system administrator. Such raw training measurement packages are forwarded to data pre-processing engine 242 for processing.

In step 702, data pre-processing engine 242 divides the set of raw training measurement packages into training and test data sets. The division may be performed randomly, by the order in which the raw training data was received, or by some other suitable criteria. Data pre-processing engine 242 forwards training data to neural network development engine 248 and test data to neural network test engine 250. In step 703, neural network development engine 248 compares a neural network's output for each measurement package in the training data to the zone associated with the measurement package. The neural network of step 703 may be an existing neural network. If a new neural network is being created, its number of nodes may be a predetermined function of the varieties of input data and the number of zones to be classified, and the relationship between two nodes may have a weight randomly assigned within predetermined boundaries. Using the backpropagation algorithm or some other suitable algorithm, neural network development engine 248 may adjust the weights of the neural network so that the neural network correctly classifies at least a predetermined proportion of measurement packages as being associated with their zones. Step 703 may repeat for a predetermined number of iterations, until the proportion of misclassified measurement packages falls below a predetermined number, or for some other suitable period. In some implementations, data pre-processing engine 242 may also classify some raw training data as validation data, and monitor the proportion of incorrect classifications of validation data measurement packages by the neural network. In such implementations, as the network is trained, if the proportion of errors in the validation data increases for a predetermined number of iterations of step 703, the neural network weights may be restored to their values when the validation error was at a minimum.

In step 704, neural network test engine 250 determines the error rate of the neural network in classifying measurement packages from the test data. If the neural network has an error rate above a predetermined threshold when classifying the test data set, process 700 may proceed to step 705, which may increase the number of hidden neurons in the neural network and return to step 703. Otherwise, in step 706 neural network development engine 248 records the neural network for use in location identification process 410.

In some implementations, one or more of steps 703-705 may be implemented using the “Neural Network Toolbox” implemented in MATLAB™ or by some other suitable implementation of a neural network training process. In some implementations, process 700 may be repeated when a predetermined amount of new raw training data is available, at predetermined intervals, on command by a system administrator, or in response to some other suitable criteria.

Process 700 may be used to generate more than one neural network for a single indoor area. As an illustrative example, process 700 may be used to generate not only a general neural network providing an overall classification of which zone a measurement package was generated in, but individual neural networks corresponding to each zone of the indoor area and indicating whether or not a measurement package is consistent with the corresponding zone.

### Content Provision

FIG. 8A is an illustrative block diagram depicting a content provision process 800 for providing a mobile device with content associated with a zone. Referring to FIGS. 1C and 2B, location server 230 may provide content to a mobile device 104 within a predetermined zone 112. Process 800 begins with step 801, in which a mobile device 104 is identified as being within an indoor area 100, in some implementations through general location identification process 400. In step 802, location server 230 identifies content associated with indoor area 100, which may include content associated with one, more than one, or no zones 112. In step 803, location server 230 may identify a location or a former location of the mobile device 104 within area 100 as described in relation to FIG. 4B. In step 804, the tracked location is compared with predetermined criteria for transmitting location-specific content. Criteria may include whether the mobile device 104 is or was in a zone 112, how long a mobile device 104 has been in a zone 112, the presence of a second mobile device 104 in a zone 112, the shopping or location history of a customer associated with mobile device 104, or some other suitable criteria. If the mobile device 104 meets the predetermined criteria, the location-specific content is transmitted to the mobile device 104, and content provision process 400 returns to step 803. Otherwise, step 806 determines whether the mobile device 104 is still within the predetermined area. If so, process 800 returns to step 803; otherwise, process 800 is complete.

FIG. 8B is an exemplary process diagram of retailer content provision process 810, in which a customer is provided with location-specific content. A customer device 812, such as mobile locational device 200 of FIG. 2A, is in communication with a retail location server 814, such as location server 230 of FIG. 2B. In accord with content provision process 800, customer device 812 transmits a measurement package 816 to retail location server 814. As depicted, retail location server 814 identifies that measurement package 816 is associated with a zone 112, and further identifies content that should be transmitted to a mobile device in zone 112. Retail location server 814 therefore sends location-specific content 818 to customer device 812. In some implementations, location-specific content 818 may not be related to the zone 112 in which the customer device 812 is located. As an illustrative example of such implementations, retail location server 814 may send a coupon to a customer to encourage the customer to move from one region of the store to another. In such implementations, the provision of location-specific content may be based on a customer purchase history, on other aspects of a customer transaction history, on the actions of previous users, or on some other suitable criteria. In some implementations, content is transmitted based on a set of zones 112 in which the customer device 812 has been located. As an illustrative example of such an implementation, retailer content provision process 810 may provide different content based on whether customer device 812 is traveling on a route consistent with a weekly shopping trip as compared to a route consistent with a brief stop-in.

FIG. 8C is an exemplary process diagram depicting a manufacturer content provision process 820, in which a manufacturer provides content associated with a predetermined area. As depicted, a customer device 822, such as mobile locational device 200 of FIG. 2A, is in communication with a retail location server 824, such as location server 230 of FIG. 2B. Retail location server 824, in turn, is in communication with a manufacturer server 826. In accord with content provision process 800, customer device 822 transmits a measurement package 828 to retail location server 824. As depicted, retail location server 824 identifies that measurement package 828 is associated with a zone 112, and may identify and transmit a user interest query 830 associated with the zone 112. As an illustrative example, if customer device 822 is in a zone 112 associated with paint, retail location server 824 may transmit content asking if the customer using customer device 822 has any questions regarding one of the paints. As depicted, customer device 822 transmits user information query 832 regardless of whether retail location server 824 has transmitted a user interest query 830. User information query 832 may be a selected from a menu of options, or may be user-generated and include text, an image, audio, video, or other suitable content. As an illustrative example of the former, a customer may be given the option of requesting more information about one or more manufacturers' products in zone 112. As an illustrative example of the latter, a customer may transmit a photo of a can of paint and text asking “how would this paint look under natural light?”

Retail location server 824 may identify the information requested by the customer and request the identified information from manufacturer server 826 with content request 824. In some implementations, user information query 832 may be directly forwarded to manufacturer server 826, which would then identify the information requested by the customer. In some implementations, retail location server 824 may also or alternatively send location or other data associated with customer device 822 to manufacturer server 826 if granted permission to do so by the user of customer device 822. Manufacturer server 826 may respond to content request 834 by identifying and transmitting manufacturer content 836 to retail location server 824. Manufacturer content 836 may include text, images, audio, or video providing information about one or more products associated with zone 112. Manufacturer content 836 may also or alternatively include coupons for one or more such products. Retail location server 824 may transmit manufacturer content 836 to customer device 822 in a form appropriate for customer device 822. In some implementations, retail location server 824 may also remove extraneous content from manufacturer content 836 before forwarding content 836. As an illustrative example of such implementations, if some manufacturer content 836 relates to products not carried by the retailer, retail location server 824 may not transmit such manufacturer content 836.

FIG. 8D is an exemplary process diagram depicting an employee provision process 840, in which employees are directed to a zone. As depicted, a customer device 842 and an employee device 846, each of which may be a mobile locational device 200 of FIG. 2A, are in communication with a location server 844, such as location server 230 of FIG. 2B. In accord with content provision process 800, customer device 842 and employee device 846 each transmit a measurement package, respectively measurement packages 850 and 848, to location server 844. As depicted, location server 844 identifies that measurement package 850 is associated with a zone 112 and that measurement package 848 is not. Location server 844 may transmit a user assistance query 852 to the customer device 842 to determine whether the customer requires assistance, and customer device 842 may transmit a user assistance request 854 to location server 844, whether independently or in response to a user assistance query 852. Location server 844 transmits a direction message 856 to employee device 846, thus directing an employee to a zone 112 in which the employee may be needed. Direction message 856 may be sent in response to a user assistance request 854, to identifying that a customer device 842 has spent at least a predetermined amount of time in the zone 112, to identifying at least a predetermined number of customer devices 842 in the zone 112, to a prediction that customer device 842 will be in zone 112, or based on some other suitable criteria.

An employee may transmit an employee acknowledgement 858 to indicate that he or she is heading to the zone indicated in direction message 856. In some implementations, other employees may be informed of the transmission of an employee acknowledgement 858, preventing multiple employees from unnecessarily traveling to the same zone. Location server 844 may respond to an employee acknowledgement 858 by transmitting an incoming employee notification 760 to customer device 842, which may indicate that an employee is coming to help, which employee is coming to help, or other suitable information. Thus, employee provision process 840 may allow a customer to request that an employee provide assistance, may automatically direct more employees to run cash registers if a large number of customers are or are expected to be waiting in a payment area, or otherwise identify how employees should be distributed in an area. In some implementations, process 840 may be adapted for use in non-retail settings, such as by providing machinery with a customer device 842 programmed to request help from a maintenance worker when one or more predetermined criteria are met.

### Alternative Implementations

While various implementations of the present disclosure have been shown and described herein, it will be obvious to those skilled in the art that such implementations are provided by way of example only. Numerous variations, changes, and substitutions will now occur to those skilled in the art without departing from the disclosure. Illustrative examples include using location information to classify what variety of trip a customer is making and providing content according to the variety of trip; associating location information with a user account and directing customer service agents with expertise relevant to the user account toward the user device. A mobile locational device may provide measurement packages without attempting to determine whether it is in an indoor area in which indoor location services are available, or Bayesian models may be used instead of neural networks to classify locations. Mobile devices may be further configured to detect dangerous conditions, such as by detecting loud sounds, and provide such information to a location server with a measurement package. In such an example, the location server may direct safety personnel to address the safety concern while warning others in the zone or in other designated zones of the danger. It should be understood that various alternatives to the implementations of the disclosure described herein may be employed in practicing the disclosure. An implementation of the systems and methods described herein may be made independently of or combined with another implementation.

The method of the present invention may be performed in either hardware, software, or any combination thereof, as those terms are currently known in the art. In particular, the present method may be carried out by software, firmware, or microcode operating on a computer or computers of any type. Additionally, software embodying the present invention may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Furthermore, such software may also be in the form of a computer data signal embodied in a carrier wave, such as that found within the well-known Web pages transferred among devices connected to the Internet. Accordingly, the present invention is not limited to any particular platform, unless specifically stated otherwise in the present disclosure.

We claim:

1. An indoor location identification system, comprising:
a communications processor configured to receive a measurement package from a mobile device in an indoor area, wherein the indoor area is associated with a plurality of zones;
a location database for storing a first model associating a plurality of measurement packages with the plurality of zones; and
a location processor in communication with the communications processor and the location database, wherein the location processor is configured to:
calculate a first plurality of probabilities based on a first measurement package and the first model, wherein the first measurement package is received by the communications processor and wherein each probability in the first plurality of probabilities is associated with a zone of the plurality of zones, and
identify a zone corresponding to the first measurement package based on the first plurality of probabilities.

2. The system of claim 1, wherein the location database is further configured to store a second model associating each zone of the plurality of zones with other zones of the plurality of zones; and
wherein the location processor is further configured to:
calculate a second plurality of probabilities based on the second measurement package and the first model, wherein the second measurement package is received by the communications processor after the first measurement package and wherein each probability in the second plurality of probabilities is associated with a zone of the plurality of zones, and
modify at least one probability of the first plurality of probabilities based on the second plurality of probabilities and the second model.

3. The system of claim 2, wherein the location processor is further configured to:
calculate a third plurality of probabilities based on a third measurement package and the first model, wherein each probability in the third plurality of probabilities is associated with a zone of the plurality of zones;
modify at least one probability of the third plurality of probabilities based on the modified first plurality of probabilities, the second plurality of probabilities, and the second model; and
identify a zone corresponding to the third measurement package based on the modified third plurality of probabilities.

4. The system of claim 3, wherein the location processor is further configured to calculate a fourth plurality of probabilities based on the second model and the zone corresponding to the third measurement package, wherein each probability in the fourth plurality of probabilities is associated with a zone of the plurality of zones.

5. The system of claim 3, wherein the location processor is further configured to modify the second model based on the zone corresponding to the third measurement package.

6. The system of claim 2, wherein the second model is a behavioral model.

7. The system of claim 2, wherein the second model is a statistical model.

8. The system of claim 1, wherein the communication processor is further configured to providing content to the mobile device based on the zone corresponding to the first measurement package.

9. The system of claim 3, wherein the communication processor is further configured to providing content to the mobile device based on the zone corresponding to the third measurement package.

10. The system of claim 4, wherein the communication processor is further configured to providing content to the mobile device based on one or more probabilities of the fourth plurality of probabilities.

11. The system of claim 1, wherein the location processor is further configured to identify a transaction associated with the mobile device.

12. The system of claim 1, wherein the location processor is further configured to identify the indoor area.

13. The system of claim 12, wherein the indoor area is identified based on the first measurement package.

14. The system of claim 12, wherein the indoor area is identified based on a Global Positioning System (GPS) measurement.

15. The system of claim 12, wherein the indoor area is identified based on a cellular tower signal.

16. The system of claim 12, wherein the indoor area is identified based on an application run by the mobile device.

17. The system of claim 1, wherein the first measurement package indicates a type of the mobile device.

18. The system of claim 1, wherein the first measurement package includes a plurality of measurements taken during a predetermined period of time.

19. The system of claim 1, wherein the first measurement package indicates an orientation of the mobile device.

20. The system of claim 1, wherein the first measurement package includes information based on a Global Positioning System (GPS) measurement.

21. The system of claim 1, wherein the first measurement package includes information based on a BLUETOOTH signal strength.

22. The system of claim 1, wherein the first measurement package includes information based on a WI-FI signal strength.

23. The system of claim 1, wherein the first measurement package includes information based on a cellular telephone signal strength.

24. The system of claim 1, wherein the first measurement package includes information based on a local magnetic field strength.

25. The system of claim 1, wherein the first measurement package includes information based on a local magnetic field direction.

26. The system of claim 1, wherein the first measurement package includes information based on a time.

27. The system of claim 1, wherein the first measurement package includes information based on a pressure.

28. The system of claim 1, wherein the first measurement package includes information based on a temperature.

29. The system of claim 1, wherein the first measurement package includes information based on gyroscope data.

30. The system of claim 1, wherein the first measurement package includes information based on video data.

31. The system of claim 1, wherein the first measurement package includes information based on audio data.

32. The system of claim 1, wherein the first measurement package includes information based on heart rate data.

33. The system of claim 1, wherein the first measurement package includes information based on respiratory rate data.

34. The system of claim 1, wherein the location processor is further configured to:
associate the identified zone with a first route comprising a sequence of identified zones associated with the mobile device, and
calculate a similarity score between the first route and a second route.

35. The system of claim 34, wherein the location processor is further configured to modify at least one probability of the first plurality of probabilities based on the similarity score.

36. The system of claim 34, wherein the communication processor is further configured to provide content to the mobile device based on the similarity score.

37. The system of claim 3, wherein the location processor is further configured to:
associate the identified zone with a first route comprising a sequence of identified zones associated with the mobile device, and
calculate a similarity score between the first route and a second route.

38. The system of claim 37, wherein the location processor is further configured to modify at least one probability of the first plurality of probabilities based on the similarity score.

39. The system of claim 37, wherein the communication processor is further configured to provide content to the mobile device based on the similarity score.

40. The system of claim 34, wherein the first route further comprises an elapsed time associated with each of the identified zones.

41. The system of claim 34, wherein the first route further comprises motion information based on the motion of the mobile device, each zone having associated motion information.

42. A computer-implemented method for identifying a zone of a plurality of zones associated with an indoor area, comprising:
receiving, from a mobile device, a first measurement package;
calculating a first plurality of probabilities based on the first measurement package, wherein each probability in the first plurality of probabilities is associated with a zone of the plurality of zones;
identifying a zone corresponding to the first measurement package based on the first plurality of probabilities.

43. The method of claim 42, further comprising:
receiving, from the mobile device, a second measurement package, wherein the second measurement package is received after the first measurement package
calculating a second plurality of probabilities based on the second measurement package, wherein each probability in the second plurality of probabilities is associated with a zone of the plurality of zones;
modifying at least one probability of the first plurality of probabilities based on the second plurality of probabilities; and

44. The method of claim 43, further comprising:
receiving, from the mobile device, a third measurement package;
calculating a third plurality of probabilities based on the third measurement package, wherein each probability in the third plurality of probabilities is associated with a zone of the plurality of zones;
modifying at least one probability of the third plurality of probabilities based on the modified first plurality of probabilities and the second plurality of probabilities; and
identifying a zone corresponding to the third measurement package based on the modified third plurality of probabilities.

45. The method of claim 44, further comprising calculating a fourth plurality of probabilities based on a model and the zone corresponding to the third measurement package, wherein each probability in the fourth plurality of probabilities is associated with a zone of the plurality of zones.

46. The method of claim 45, wherein the model is a behavioral model.

47. The method of claim 45, wherein the model is a statistical model.

48. The method of claim 44, wherein the first plurality is calculated using a model, and further comprising modifying the model based on the zone corresponding to the third measurement package.

49. The method of claim 42, further comprising providing content to the mobile device based on the zone corresponding to the first measurement package.

50. The method of claim 44, further comprising providing content to the mobile device based on the zone corresponding to the third measurement package.

51. The method of claim 45, further comprising providing content to the mobile device based on one or more probabilities of the fourth plurality of probabilities.

52. The method of claim 42, further comprising identifying a transaction associated with the mobile device.

53. The method of claim 42, further comprising identifying the indoor area.

54. The method of claim 53, wherein the indoor area is identified based on the first measurement package.

55. The method of claim 53, wherein the indoor area is identified based on a Global Positioning System (GPS) measurement.

56. The method of claim 53, wherein the indoor area is identified based on a cellular tower signal.

57. The method of claim 53, wherein the indoor area is identified based on an application run by the mobile device.

58. The method of claim 42, wherein the first measurement package indicates a type of the mobile device.

59. The method of claim 42, wherein the first measurement package includes a plurality of measurements taken during a predetermined period of time.

60. The method of claim 42, wherein the first measurement package indicates an orientation of the mobile device.

61. The method of claim 42, wherein the first measurement package includes information based on a Global Positioning System (GPS) measurement.

62. The method of claim 42, wherein the first measurement package includes information based on a BLUETOOTH signal strength.

63. The method of claim 42, wherein the first measurement package includes information based on a WI-FI signal strength.

64. The method of claim 42, wherein the first measurement package includes information based on a cellular telephone signal strength.

65. The method of claim 42, wherein the first measurement package includes information based on a local magnetic field strength.

66. The method of claim 42, wherein the first measurement package includes information based on a local magnetic field direction.

67. The method of claim 42, wherein the first measurement package includes information based on a time.

68. The method of claim 42, wherein the first measurement package includes information based on a pressure.

69. The method of claim 42, wherein the first measurement package includes information based on a temperature.

70. The method of claim 42, wherein the first measurement package includes information based on gyroscope data.

71. The method of claim 42, wherein the first measurement package includes information based on video data.

72. The method of claim 42, wherein the first measurement package includes information based on audio data.

73. The method of claim 42, wherein the first measurement package includes information based on heart rate data.

74. The method of claim 42, wherein the first measurement package includes information based on respiratory rate data.

75. The method of claim 42, further comprising:
associating the identified zone with a first route comprising a sequence of identified zones associated with a mobile device, and
calculating a similarity score between the first route and a second route.

76. The method of claim 75, further comprising modifying at least one probability of the first plurality of probabilities based on the similarity score.

77. The method of claim 75, further comprising providing content to the mobile device based on the similarity score.

78. The method of claim 44, further comprising:
associating the identified zone with a first route comprising a sequence of identified zones associated with a mobile device, and
calculating a similarity score between the first route and a second route.

79. The method of claim 78, further comprising modifying at least one probability of the third plurality of probabilities based on the similarity score.

80. The method of claim 78, further comprising providing content to the mobile device based on the similarity score.

81. The method of claim 75, wherein the first route further comprises an elapsed time associated with each of the identified zones.

82. The method of claim 75, wherein the first route further comprises motion information based on the motion of the mobile device, each zone having associated motion information.
